(19) United States
(12) Patent Application Publication
(10) Pub. No.: US 2021/0269592 A1
(43) Pub. Date: Sep. 2, 2021

(54) FLUORINATED COMPOUND, FLUORINATED COMPOUND-CONTAINING COMPOSITION, COATING LIQUID, ARTICLE, AND METHOD OF PRODUCING THE SAME

(71) Applicant: AGC Inc., Tokyo (JP)

(72) Inventors: Eiichiro ANRAKU, Chiyoda-ku (JP); Keigo MATSUURA, Chiyoda-ku (JP); Taiki HOSHINO, Chiyoda-ku (JP)

(73) Assignee: AGC Inc., Tokyo (JP)

(21) Appl. No.: 17/315,454

(22) Filed: May 10, 2021

Related U.S. Application Data
(63) Continuation of application No. PCT/JP2019/046023, filed on Nov. 25, 2019.

(30) Foreign Application Priority Data
Nov. 28, 2018 (JP) 2018-222871

(51) Int. Cl. C08G 65/323; C09D 171/00; B05D 5/08; C08G 65/336

(52) U.S. Cl. CPC C08G 65/3236; C09D 171/00; B05D 1/18; C08G 65/336; B05D 5/083

(57) ABSTRACT

A fluorinated compound and a fluorinated compound-containing composition which enable formation of a surface layer having high friction resistance and fingerprint marks removability even if the fluorinated compound has a fluorinated organic group having a shorter chain are provided. A coating liquid, an article including the surface layer on its surface, and a method of producing the same are also provided.

A fluorinated compound represented by [(R^{f}-A-)₂N-]ₐ₁Q¹[-T]_{b1} (wherein R^{f}: a fluoroalkyl group or a group having —O— between carbon atoms of a fluoroalkyl group having two or more carbon atoms, A: a divalent organic group having no fluorine atom, Q¹: a a1+b1 valent organic group, T: —Si(R)_{3-c}(L)_{c}, R: an alkyl group, L: a hydrolyzable group or a hydroxyl group, a1: an integer of 1 or more, b1: an integer of 2 or more, and c: 2 or 3).

### INCORPORATION BY REFERENCE

This application is based upon and claims the benefit of priority from Japanese Patent Application 2018-222871 filed on Nov. 28, 2018, and PCT application No. PCT/JP2019/046023 filed on Nov. 25, 2019, the disclosure of which is incorporated herein in its entirety by reference.

### BACKGROUND

The present invention relates to a fluorinated compound, a fluorinated compound-containing composition, a coating liquid, an article, and a method of producing the same.

Fluorinated compounds having a fluoroalkyl group, a fluorinated organic group such as a fluoropolyether chain, and a hydrolyzable silyl group enable formation of a surface layer having high lubrication and water/oil repellency on surfaces of substrates, and therefore can be suitably used as a surface treatment agent. The surface treatment agent containing such a fluorinated compound is used in applications that requires long-term maintenance of the performance (friction resistance) to hardly reduce water/oil repellency even after repeated rubbing of the surface layer with fingers and the performance (fingerprint marks removability) to facilitate the removal of fingerprints adhering to the surface layer, for example, as a surface treatment agent for a member constituting a plane of a touch panel to be touched with fingers, lenses for eye glasses, and displays for wearable terminals.

As a fluorinated compound which enables formation of a surface layer having high friction resistance and fingerprint marks removability on the surface of a substrate, a fluorinated compound having a plurality of fluoropolyether chains and a plurality of hydrolyzable silyl groups is proposed (compounds (1-2), (1-4), (1-5), (1-7), and (1-8) described in paragraph [0049] of WO2017/187775).

### SUMMARY

The surface treatment agent is also used in surface treatment of rear surfaces (surfaces opposite to the display screens) of mobile devices such as smartphones and tablet terminals in some cases.

The present inventors have evaluated a substrate with a surface layer prepared by surface treating the entire main surface of the substrate with a surface treatment agent containing the fluorinated compound. The evaluation has revealed that while the surface layer has good fingerprint marks removability, the surface layer has poor slip resistance (that is, the surface layer is slippery). For example, when the substrate with the surface layer is used in a mobile device, the mobile device may slip down when a user operates the mobile device or places it on a desk or the like. For this reason, the surface layer disposed on the rear surface of the mobile device requires slip resistance in addition to friction resistance and fingerprint marks removability.

The present inventors, who have conducted research, have found that a fluorinated organic group having a shorter chain tends to enhance the slip resistance of the surface layer. However, a reduction in length of the chain of the fluorinated organic group tends to result in a reduction in friction resistance and fingerprint marks removability of the surface layer.

An object of the present invention is to provide a fluorinated compound, a fluorinated compound-containing composition, and a coating liquid which can provide a surface layer having high friction resistance and fingerprint marks removability even if the fluorinated compound includes a fluorinated organic group having a shorter chain, an article including a surface layer having high friction resistance and fingerprint marks removability even if the fluorinated compound includes a fluorinated organic group having a shorter chain, and a method of producing the article.

The present invention provides a fluorinated compound, a fluorinated compound-containing composition, a coating liquid, an article, and a method of producing an article according to Aspects [1] to [14] as follows:
[1] A fluorinated compound which is a compound represented by the following formula (1A) or a compound represented by the following formula (1B):

[(R^{f}-A-)₂N-]ₐ₁Q¹[-T]_{b1} (1A)

[T-]_{b2}[(R^{f}-A-)₂N-]ₐ₂Q²-N(R¹⁰)₁₋ₐ₃(-A-R^{f})ₐ₃-A-Q^{f}-A-N(R¹⁰)₁₋ₐ₃(-A-R^{f})ₐ₃-Q²[- N(-A-R^{f})₂]ₐ₂[-T]_{b2} (1B)

wherein R^{f} is a fluoroalkyl group (having at least one fluorine atom bonded to the terminal carbon atom on the A side) or a group having —O— between carbon atoms of a fluoroalkyl group having two or more carbon atoms (having at least one fluorine atom bonded to the terminal carbon atom on the A side), and two or more R^{f} in the formulae (1A) and (1B) may be the same or different;

Q^{f} is a fluoroalkylene group (having at least one fluorine atom bonded to the terminal carbon atom on the A side) or a group having —O— between carbon atoms of a fluoroalkylene group having two or more carbon atoms (having at least one fluorine atom bonded to the terminal carbon atom on the A side);

A is a divalent organic group having no fluorine atom, and two or more A in the formulae (1A) and (1B) may be the same or different;

Q¹ is a a1+b1 valent organic group;

Q² is a a2+b2+1 valent organic group, and two Q² may be the same or different;

R¹⁰ is a hydrogen atom or a hydrocarbon group having 1 to 6 carbon atoms, and two or more R¹⁰ may be the same or different;

T is —Si(R)_{3-c}(L)_{c};

R is an alkyl group;

L is a hydrolyzable group or a hydroxyl group, and two or more L may be the same or different;

a1 is an integer of 1 or more, a2 is an integer of 0 or more, and two or more [(R^{f}-A-)₂N—] may be the same or different;

a3 is 0 or 1, and a2+a3≥1;

b1 and b2 each are an integer of 2 or more, and two or more T may be the same or different; and

c is 2 or 3; and wherein

in the compound represented by the formula (1B), two monovalent groups bonded through Q^{f} may be the same or different.
[2] The fluorinated compound according to Aspect [1], wherein the compound represented by the formula (1B) is a compound represented by the following formula (1BX):

{[T-]_{b2}[(R^{f}-A-)₂N-]ₐ₂Q²-N(R¹⁰)₁₋ₐ₃(-A-R^{f})ₐ₃-A-}₂Q^{f} (1BX)
[3] The fluorinated compound according to Aspect [1] or [2], wherein R^{f} is a group represented by the following formula (g1a):

R^{f1}—(OR^{f2})ₘ— (g1a)

wherein R^{f1} is a fluoroalkyl group having 1 to 6 carbon atoms (having at least one fluorine atom bonded to the terminal carbon atom on the A side when m is 0);

R^{f2} is a fluoroalkylene group having 1 to 6 carbon atoms (having at least one fluorine atom bonded to the terminal carbon atom on the A side of R^{f2} which is bonded to A); and

m is an integer of 0 or more, and when m is 2 or more, (OR^{f2})ₘ may include two or more OR^{f2}.
[4] The fluorinated compound according to any one of Aspects [1] to [3], wherein R^{f} and Q^{f} each have a molecular weight of 50 to 1000.
[5] The fluorinated compound according to any one of Aspects [1] to [4], wherein A is —(CH₂)ₙ—, —C(O)—, —(CH₂)ₙ—NHC(O)—, —C(O)NH—(CH₂)ₙ—C(O)—, or —C(O)NH—(CH₂)ₙ— (where n is an integer of 1 or more).
[6] The fluorinated compound according to any one of Aspects [1] to [5], wherein Q¹ is a group represented by formula (g2-1) (where a1=d1+d3 and b1=d2+d4), a group represented by formula (g2-2) (where a1=e1 and b1=e2), a group represented by formula (g2-3) (where a1=1 and b1=2), a group represented by formula (g2-4) (where a1=h1 and b1=h2), or a group represented by formula (g2-5) (where a1=i1 and b1=i2); and

Q² is a group represented by the formula (g2-1) (where a2+1=d1+d3 and b2=d2+d4), a group represented by the formula (g2-2) (where a2+1=e1 and b2=e2), a group represented by the formula (g2-3) (where a2+1=1 and b2=2), a group represented by the formula (g2-4) (where a2+1=h1 and b2=h2), or a group represented by the formula (g2-5) (where a2+1=i1 and b2=i2):

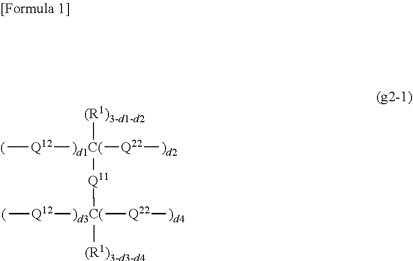

(-Q¹²-)ₑ₁C(R²)₄₋ₑ₁₋ₑ₂(-Q²²-)ₑ₂ (g2-2)

-Q¹³-N(-Q²³-)₂ (g2-3)

(-Q¹⁴-)ₕ₁Z(-Q²⁴-)ₕ₂ (g2-4)

(-Q¹⁵-)ᵢ₁Si(R³)₄₋ᵢ₁₋ᵢ₂(-Q²⁵-)ᵢ₂ (g2-5)

wherein in the formulae (g2-1) to (g2-5), the Q¹², Q¹³, Q¹⁴, and Q¹⁵ sides are linked to a nitrogen atom of [(R^{f}-A-)₂N—] or —N(R¹⁰)₁₋ₐ₃(-A-R^{f})ₐ₃—, and the Q²², Q²³, Q^{24,} and Q²⁵ sides are linked to T;

Q¹¹ is a single bond, —O—, an alkylene group, or a group having —O— between carbon atoms of an alkylene group having two or more carbon atoms;

Q¹² is a single bond, —C(O)—, or an alkylene group, and when Q¹ or Q² has two or more Q¹², the two or more Q¹² may be the same or different;

Q¹³ is an alkylene group;

Q¹⁴ is Q¹² when the atom in Z to which Q¹⁴ is bonded is a carbon atom, and is Q¹³ when the atom in Z to which Q¹⁴ is bonded is a nitrogen atom; and when Q¹ or Q² has two or more Q¹⁴, the two or more Q¹⁴ may be the same or different;

Q¹⁵ is an alkylene group, and when Q¹ or Q² has two or more Q¹⁵, the two or more Q¹⁵ may be the same or different;

Q²² is an alkylene group, a group having —C(O)NH—, —C(O)—, or —O— between carbon atoms of an alkylene group having two or more carbon atoms, a group having —C(O)NH—, —C(O)—, or —O— in a terminal of an alkylene group not linked to Si, or a group having —C(O)NH—, —C(O)—, or —O— between carbon atoms of an alkylene group having two or more carbon atoms and having —C(O)NH—, —C(O)—, or —O— in a terminal not linked to Si, and two or more Q²² may be the same or different;

Q²³ is an alkylene group or a group having —C(O)NH—, —C(O)—, or —O— between carbon atoms of an alkylene group having two or more carbon atoms, and two Q²³ may be the same or different;

Q²⁴ is Q²² when the atom in Z to which Q²⁴ is bonded is a carbon atom, and is Q²³ when the atom in Z to which Q²⁴ is bonded is a nitrogen atom, and two or more Q²⁴ may be the same or different;

Q²⁵ is an alkylene group or a group having —C(O)NH—, —C(O)—, or —O— between carbon atoms of an alkylene group having two or more carbon atoms, and two or more Q²⁵ may be the same or different;

Z is a group having a a1+b1 valent or a2+b2+1 valent cyclic structure having a carbon atom or a nitrogen atom directly bonded by Q¹⁴ and a carbon atom or a nitrogen atom directly bonded by Q²⁴;

R¹ is a hydrogen atom or an alkyl group, and when Q¹ or Q² has two or more R¹, the two or more R¹ may be the same or different;

R² is a hydrogen atom or an alkyl group;

R³ is an alkyl group;

d1 is an integer of 0 to 3, d2 is an integer of 0 to 3, and d1+d2 is an integer of 1 to 3;

d3 is an integer of 0 to 3, d4 is an integer of 0 to 3, and d3+d4 is an integer of 1 to 3;

d1+d3 is an integer of 1 to 4, and d2+d4 is an integer of 2 to 5;

e1 is 1 or 2, e2 is 2 or 3, and e1+e2 is 3 or 4;

h1 is an integer of 1 or more, and h2 is an integer of 2 or more;

i1 is 1 or 2, i2 is 2 or 3, and i1+i2 is 3 or 4.
[7] A fluorinated compound-containing composition, comprising at least one type of the fluorinated compound according to any one of Aspects [1] to [6], and other fluorinated compound.
[8] A coating liquid, comprising the fluorinated compound according to any one of Aspects [1] to [6] or the fluorinated compound-containing composition according to Aspect [7]; and a liquid medium.
[9] An article comprising a substrate and a surface layer formed of the fluorinated compound according to any one of Aspects [1] to [6] or the fluorinated compound-containing composition according to Aspect [7] on a surface of the substrate.
[10] The article according to Aspect [9], which has the surface layer on a surface of a member constituting a plane of a touch panel to be touched with fingers.
[11] A method of producing an article, comprising treating a surface of a substrate by dry coating method using the fluorinated compound according to any one of Aspects [1] to [6] or the fluorinated compound-containing composition according to Aspect [7] to form a surface layer formed of the fluorinated compound or the fluorinated compound-containing composition on the surface of the substrate.
[12] A method of producing an article, comprising applying the coating liquid according to Aspect [8] onto a surface of a substrate by wet coating method followed by drying to form a surface layer formed of the fluorinated compound or the fluorinated compound-containing composition on the surface of the substrate.
[13] A fluorinated compound which is a compound represented by the following formula (2A) or a compound represented by the following formula (2B):

[(R^{f}-A-)₂N-]ₐ₁Q¹⁰[-CH═CH₂]_{b1} (2)

[CH₂═CH—]_{b2}[(R^{f}-A-)₂N-]ₐ₂Q²⁰-N(-A-R^{f})-A-Q^{f}-A-N(-A-R^{f})-Q²⁰[-N(-A-R^{f})₂]ₐ₂[—CH═CH₂]_{b2} (2B)

wherein R^{f} is a fluoroalkyl group (having at least one fluorine atom bonded to the terminal carbon atom on the A side) or a group having —O— between carbon atoms of a fluoroalkyl group having two or more carbon atoms (having at least one fluorine atom bonded to the terminal carbon atom on the A side), and two or more R^{f} in the formulae (2A) and (2B) may be the same or different;

Q^{f} is a fluoroalkylene group (having at least one fluorine atom bonded to the terminal carbon atom on the A side) or a group having —O— between carbon atoms of a fluoroalkylene group having two or more carbon atoms (having at least one fluorine atom bonded to the terminal carbon atom on the A side);

A is a divalent organic group having no fluorine atom, and two or more A in the formulae (2A) and (2B) may be the same or different;

Q¹⁰ is a a1+b1 valent organic group;

Q²⁰ is a a2+b2+1 valent organic group, and two Q²⁰ may be the same or different;

a1 is an integer of 1 or more, a2 is an integer of 0 or more, and two or more [(R^{f}-A-)₂N-] may be the same or different; and

b1 and b2 each are an integer of 2 or more; and wherein

in the compound represented by the formula (2B), two monovalent groups bonded through Q^{f} may be the same or different.
[14] The fluorinated compound according to Aspect [13], wherein the compound represented by the formula (2B) is a compound represented by the following formula (2BX):

{[CH₂═CH—]_{b2}[(R^{f}-A-)₂N-]ₐ₂Q²⁰-N(-A-R^{f})-A-}₂Q^{f} (2BX)

The fluorinated compound according to the present invention enables formation of a surface layer having high fingerprint marks removability and friction resistance even if the fluorinated compound includes a fluorinated organic group having a shorter chain.

The fluorinated compound-containing composition according to the present invention enables formation of a surface layer having high fingerprint marks removability and friction resistance even if the fluorinated compound includes a fluorinated organic group having a shorter chain.

The coating liquid according to the present invention enables of a surface layer having high fingerprint marks removability and friction resistance even if the fluorinated compound includes a fluorinated organic group having a shorter chain.

The article according to the present invention includes a surface layer having high fingerprint marks removability and friction resistance even if the fluorinated compound includes a fluorinated organic group having a shorter chain.

The method of producing an article according to the present invention can provide an article including a surface layer having high fingerprint marks removability and friction resistance even if the fluorinated compound includes a fluorinated organic group having a shorter chain.

The above and other objects, features and advantages of the present disclosure will become more fully understood from the detailed description given hereinbelow and the accompanying drawings which are given by way of illustration only, and thus are not to be considered as limiting the present disclosure.

### DESCRIPTION OF EMBODIMENTS

In this specification, a compound represented by formula (1A) is referred to as compound (1A), and a compound represented by formula (1B) is referred to as a compound (1B). The same also applies to compounds represented by other formulae. The compound (1A) and the compound (1B) are also collectively referred to as compound (1).

A group represented by formula (g1a) is referred to as group (g1a). The same also applies to groups represented by other formulae.

In the chemical formulae of oxyfluoroalkylene units, each oxyfluoroalkylene unit is represented as a fluoroalkylene group and an oxygen atom added to the left side of the fluoroalkylene group.

Meanings of terms used in this specification are defined as follows.

The “hydrolyzable silyl group” indicates a group which can undergo a hydrolysis reaction to form a silanol group (Si—OH). The hydrolyzable silyl group or the silanol group is T(-Si(R)_{3-c}(L)_{c}) in the formula (1A) or (1B), for example. Hereinafter, the hydrolyzable silyl group and the silanol group are also collectively referred to as “reactive silyl group”.

The “surface layer” indicates a layer formed on a surface of a substrate.

If the fluorinated compound is a mixture of a plurality of fluorinated compounds having different fluoropolyether chain lengths, the “molecular weight” of R^{f} or Q^{f} indicates a number average molecular weight obtained by calculation from the number (average) of oxyfluoroalkylene units determined by ¹H-NMR and ¹⁹F-NMR using terminal groups as references. Examples of the terminal groups include R^{f1} in the formula (g1a) and T in the formulae (1A) and (1B).

If the fluorinated compound has a single chain length of R^{f} or Q^{f}, the “molecular weight” of R^{f} or Q^{f} indicates a molecular weight obtained by calculation from the structure of R^{f} or Q^{f} determined by ¹H-NMR and ¹⁹F-NMR.

### [Fluorinated Compound]

The fluorinated compound according to the present invention is a compound (1A) or a compound (1B).

[(R^{f}-A-)₂N-]ₐ₁Q¹[-T]_{b1} (1A)

[T-]_{b2[(R}^{f}-A-)₂N-]ₐ₂Q²-N(R¹⁰)₁₋ₐ₃(-A-R^{f})ₐ₃-A-Q^{f}-A-N(R¹⁰)₁₋ₐ₃(-A-R^{f})ₐ₃-Q²[- N(-A-R^{f})₂]ₐ₂[-T]_{b2} (1B)

Here, R^{f} is a fluoroalkyl group (having at least one fluorine atom bonded to the terminal carbon atom on the A side) or a group having —O— between carbon atoms of a fluoroalkyl group having two or more carbon atoms (having at least one fluorine atom bonded to the terminal carbon atom on the A side), and two or more R^{f} in the formulae (1A) and (1B) may be the same or different. Q^{f} is a fluoroalkylene group (having at least one fluorine atom bonded to the terminal carbon atom on the A side) or a group having —O— between carbon atoms of a fluoroalkylene group having two or more carbon atoms (having at least one fluorine atom bonded to the terminal carbon atom on the A side). A is a divalent organic group having no fluorine atom, and two or more A in the formulae (1A) and (1B) may be the same or different. Q¹ is a a1+b1 valent organic group. Q² is a a2+b2+1 valent organic group, and two Q² may be the same or different. R¹⁰ is a hydrogen atom or a hydrocarbon group having 1 to 6 carbon atoms, and two or more R¹⁰ may be the same or different. T is —Si(R)₃₋ₑ(L)_{c}; R is an alkyl group; L is a hydrolyzable group or a hydroxyl group; c is 2 or 3; and two or more L may be the same or different. a1is an integer of 1 or more; a2 is an integer of 0 or more; and two or more [(R^{f}-A-)₂N—] may be the same or different. a3 is 0 or 1; a2+a3≥1. b1 and b2 are each an integer of 2 or more; and two or more T may be the same or different.

In the compound (1B), two monovalent groups linked through Q^{f} may be the same or different. In other words, at least one of A, Q², R¹⁰, R^{f}, T, a2, a3, and b2 may be different in the two groups represented by [T-]_{b2}[(R^{f}-A-)₂N-]ₐ₂Q²-N(R¹⁰)₁₋ₐ₃(-A-R^{f})ₐ₃-A- included in the compound (1B).

To facilitate preparation of the compound (1B), the compound (1B) preferably has two identical monovalent groups linked through Q^{f}. The compound (1B) having two identical monovalent groups linked through Q^{f} is represented by the following formula (1BX):

{[T-]_{b2}[(R^{f}-A-)₂N-]ₐ₂Q²-N(R¹⁰)₁₋ₐ₃(-A-R⁴)ₐ₃-A-}₂Q^{f} (1BX)

The compound (1A) has a plurality of R^{f}. The compound (1A) having a plurality of R^{f} in the terminals has high fingerprint marks removability of the surface layer. The compound (1B) provides a plurality of R^{f} in addition to Q^{f}. The compound (1B) having a plurality of R^{f} in addition to Q^{f} has high fingerprint marks removability of the surface layer.

The compound (1) has a plurality of reactive silyl groups. The compound (1) having a plurality of reactive silyl groups in the terminals strongly chemically bonds to the substrate, and has high friction resistance of the surface layer.

To facilitate the preparation of the compound (1A) and provide a surface layer having further enhanced friction resistance and fingerprint marks removability, a1 is preferably 1 to 6, more preferably 1 to 4, particularly preferably 1 or 2. To facilitate the preparation of the compound (1B) and provide a surface layer having further enhanced friction resistance and fingerprint marks removability, a2 is preferably 0 to 6, more preferably 0 to 4, particularly preferably 0 to 2.

To facilitate the preparation of the compound (1A) and provide a surface layer having further enhanced friction resistance and fingerprint marks removability, b1 is preferably 2 to 6, more preferably 2 to 5, particularly preferably 2 to 4. To facilitate the preparation of the compound (1B) and provide a surface layer having further enhanced friction resistance and fingerprint marks removability, b2 is preferably 2 to 6, more preferably 2 to 5, particularly preferably 2 to 4.

To facilitate the preparation of the compound (1B) and provide a surface layer having further enhanced friction resistance and fingerprint marks removability, a3 is preferably 1. If a3 is 0, an alkyl group is preferred as the hydrocarbon group for R¹⁰ to facilitate the preparation of the compound (1B). The hydrocarbon group for R¹⁰ has preferably 1 to 3 carbon atoms, and particularly preferably has 1 to 2 carbon atoms.

R^{f} is a monovalent fluorinated organic group. R^{f} is preferably a fluoropolyether chain because it further enhances the fingerprint marks removability of the surface layer. The fluoropolyether chain is a group having a plurality of —O— between carbon atoms of a fluoroalkyl group. The fluoropolyether chain usually has an oxyfluoroalkylene unit. R^{f} is more preferably a perfluoropolyether chain because it further enhances the friction resistance and fingerprint marks removability of the surface layer.

Q^{f} is a divalent fluorinated organic group. Q^{f} is preferably a fluoropolyether chain because it further enhances the fingerprint marks removability of the surface layer. Q^{f} is more preferably a perfluoropolyether chain because it further enhances the friction resistance and fingerprint marks removability of the surface layer.

R^{f} and Q^{f} each have a molecular weight of preferably 50 to 1000, more preferably 100 to 900, particularly preferably 200 to 800 to provide compatibility between the fingerprint marks removability of the resulting surface layer and the slip resistance thereof. If R^{f} and Q^{f} have a molecular weight equal to or higher than the lower limit value in the range above, the surface layer has further enhanced fingerprint marks removability. If R^{f} and Q^{f} have a molecular weight equal to or less than the upper limit value in the range above, the resulting surface layer has further enhanced slip resistance.

To provide a surface layer having further enhanced friction resistance and fingerprint marks removability, R^{f} and Q^{f} have a molecular weight of preferably 1500 to 10000, more preferably 2000 to 8000, particularly preferably 2500 to 6000. If R^{f} and Q^{f} have a molecular weight equal to or higher than the lower limit value in the range above, the surface layer has further enhanced friction resistance and fingerprint marks removability. If R^{f} and Q^{f} have a molecular weight equal to or less than the upper limit value in the range above, the surface layer has further enhanced friction resistance.

Examples of R^{f} include a group (g1a):

R^{f1}—(OR^{f2})ₘ— (g1a)

wherein R¹¹ is a fluoroalkyl group having 1 to 6 carbon atoms (having at least one fluorine atom bonded to the terminal carbon atom on the A side when m is 0); R^{f2} is a fluoroalkylene group having 1 to 6 carbon atoms (having at least one fluorine atom bonded to the terminal carbon atom on the A side of R^{f2} which is bonded to A); m is an integer of 0 or more, and when m is 2 or more, (OR^{f2})ₘ may include two or more OR^{f2}.

Examples of Q^{f} include groups having a group (g1b):

—R^{f2}(OR^{f2})_{m′—} (g1b)

wherein R^{f2} is a fluoroalkylene group having 1 to 6 carbon atoms (having at least one fluorine atom bonded to the terminal carbon atom on the A side of R^{f2} which is bonded to A); m′ is an integer of 1 or more; and when m′ is 2 or more, (OR^{f2})_{m′} may include two or more OR^{f2}.

If R^{f1} has 1 to 6 carbon atoms, the resulting surface layer has further enhanced friction resistance and fingerprint marks removability. To provide a surface layer having further enhanced friction resistance and fingerprint marks removability, the fluoroalkyl group for R^{f1} preferably has 1 to 4 carbon atoms, and particularly preferably 1 to 3 carbon atoms.

To provide a surface layer having further enhanced friction resistance and fingerprint marks removability, R^{f1} is preferably a perfluoroalkyl group. The compound (1A) wherein R^{f1} is a perfluoroalkyl group has CF₃— in the terminal. The compound (1A) having CF₃— in the terminal enables formation of a surface layer having low surface energy, resulting in further enhanced friction resistance and fingerprint marks removability of the surface layer.

Examples of R^{f1} include CF₃—, CF₃CF₂—, CF₃CF₂CF₂—, CF₃CF₂CF₂CF₂—, CF₃CF₂CF₂CF₂CF₂—, CF₃CF₂CF₂CF₂CF₂CF₂—, and CF₃CF(CF₃)—.

If R^{f2} has 1 to 6 carbon atoms, the surface layer has further enhanced friction resistance and fingerprint marks removability.

To provide a surface layer having further enhanced friction resistance and fingerprint marks removability, R^{f2} is preferably a linear fluoroalkylene group.

To provide a surface layer having further enhanced friction resistance and fingerprint marks removability, R^{f2} is preferably a perfluoroalkylene group.

To provide a surface layer having further enhanced friction resistance and fingerprint marks removability, the proportion of the perfluoroalkylene group in all the R^{f2} is preferably 60 mol % or more, more preferably 80 mol % or more, particularly preferably 100 mol %.

If the surface layer should have sufficient slip resistance, m is an integer of preferably 0 to 30, more preferably 0 to 20, particularly preferably 0 to 10. If m is equal to or less than the upper limit value in the range above, the surface layer has further enhanced slip resistance. If the surface layer should have sufficient slip resistance, m′ is an integer of preferably 1 to 30, more preferably 1 to 20, particularly preferably 1 to 10. If m′ is equal to or less than the upper limit value in the range above, the surface layer has further enhanced slip resistance.

If the surface layer should have sufficient friction resistance and fingerprint marks removability, m and m′ are an integer of preferably 2 to 200, more preferably 5 to 150, particularly preferably 10 to 100. If m and m′ are equal to or more than the lower limit value in the range above, the surface layer has further enhanced friction resistance and fingerprint marks removability. If m and m′ are equal to or less than the upper limit value in the range above, the surface layer has further enhanced friction resistance. In other words, if the compound (1) has a significantly large number average molecular weight, the number of hydrolyzable silyl groups present per unit molecular weight is reduced, and thus the friction resistance of the surface layer is reduced.

Examples of OR^{f2}, i.e., oxyfluoroalkylene units include OCHF, OCF₂CHF, OCHFCF₂, OCF₂CH₂, OCH₂CF₂, OCF₂CF₂CHF, OCHFCF₂CF₂, OCF₂CF₂CH₂, OCH₂CF₂CF₂, OCF₂CF₂CF₂CH₂, OCH₂CF₂CF₂CF₂, OCF₂CF₂CF₂CF₂CH₂, OCH₂CF₂CF₂CF₂CF₂, OCF₂CF₂CF₂CF₂CF₂CH₂, OCH₂CF₂CF₂CF₂CF₂CF₂, OCF₂, OCF₂CF₂, OCF₂CF₂CF₂, OCF(CF₃)CF₂, OCF₂CF₂CF₂CF₂, OCF(CF₃)CF₂CF₂, OCF₂CF₂CF₂CF₂CF₂, and OCF₂CF₂CF₂CF₂CF₂CF₂.

If two or more OR^{f2} are present in (OR^{f2})ₘ and (OR^{f2})_{m′}, these OR^{f2} can bond in any order. For example, if OCF₂ and OCF₂CF₂ are present, OCF₂ and OCF₂CF₂ may be arranged at random, alternately, or in blocks.

The presence of two or more OR^{f2} indicates that two or more OR^{f2} having different carbon atoms are present, that two or more OR^{f2} having different numbers of hydrogen atoms are present, that two or more OR^{f2} having hydrogen atoms in different positions are present, and that two or more OR^{f2} having the same number of carbon atoms while having or not having the side chain or having different side chains (such as the number of side chains and the number of carbon atoms in the side chain) are present.

An exemplary arrangement of the two or more OR^{f2} is the structure represented by {(OCF₂)ₘ₁ (OCF₂CF₂)ₘ₂} where the number (m1) of (OCF₂) and the number (m2) of (OCF₂CF₂) are arranged at random. Another exemplary arrangement of the two or more OR^{f2} is the structure represented by (OCF₂CF₂—OCF₂CF₂CF₂CF₂)ₘ₅ where the number (m5) of (OCF₂CF₂) and the number (m5) of (OCF₂CF₂CF₂CF₂) are arranged alternately.

Preferred (OR^{f2})ₘ and (OR^{f2})_{m′} are those having the following structure in at least part thereof:

{(OCF₂)ₘ₁(OCF₂CF₂)ₘ₂},

(OCF₂CF₂)ₘ₃,

(OCF₂CF₂CF₂)ₘ₄,

(OCF₂CF₂—OCF₂CF₂CF₂CF₂)ₘ₅,

(OCF₂CF₂CF₂CF₂CF₂)ₘ₆(OCF₂)ₘ₇,

(OCF₂CF₂CF₂CF₂CF₂)ₘ₆(OCF₂CF₂)ₘ₇,

(OCF₂CF₂CF₂CF₂CF₂CF₂)ₘ₆(OCF₂)ₘ₇,

(OCF₂CF₂CF₂CF₂CF₂CF₂)ₘ₆(OCF₂CF₂)ₘ₇,

(OCF₂CF₂CF₂CF₂CF₂—OCF₂)ₘ₈,

(OCF₂CF₂CF₂CF₂CF₂—OCF₂CF₂)ₘ₈,

(OCF₂CF₂CF₂CF₂CF₂CF₂—OCF₂)ₘ₈,

(OCF₂CF₂CF₂CF₂CF₂CF₂—OCF₂CF₂)ₘ₈,

(OCF₂—OCF₂CF₂CF₂CF₂CF₂)ₘ₈,

(OCF₂—OCF₂CF₂CF₂CF₂CF₂CF₂)ₘ₈,

(OCF₂CF₂—OCF₂CF₂CF₂CF₂CF₂)ₘ₈,

(OCF₂CF₂—OCF₂CF₂CF₂CF₂CF₂CF₂)ₘ₈,

(OCF(CF₃)CF₂)ₘ₉

where m1, m2, m3, m4, m5, m6, m7, m8, and m9 are an integer of 1 or more. The upper limit values of m1, m2, m3, m4, m5, m6, m7, m8, and m9 are adjusted according to the upper limit value of m.

To facilitate the preparation of the compound (1), (OR^{f2})ₘ and (OR^{f2})_{m′} are preferably the followings:

{(OCF₂)ₘ₁(OCF₂CF₂)ₘ₂}OCF₂,

(OCF₂CF₂)ₘ₃OCF₂,

(OCF₂CF₂CF₂)ₘ₄OCF₂CF₂,

(OCF₂CF₂)₂{(OCF₂)ₘ₁(OCF₂CF₂)ₘ₂}OCF₂,

(OCF₂CF₂—OCF₂CF₂CF₂CF₂)ₘ₅OCF₂CF₂OCF₂CF₂CF₂,

(OCF₂—OCF₂CF₂CF₂CF₂CF₂)ₘ₈OCF₂OCF₂CF₂CF₂CF₂,

(OCF₂—OCF₂CF₂CF₂CF₂CF₂CF₂)ₘ₈OCF₂OCF₂CF₂CF₂CF₂CF₂,

(OCF₂CF₂—OCF₂CF₂CF₂CF₂CF₂)ₘ₈OCF₂ CF₂ OCF₂CF₂CF₂CF₂,

(OCF₂CF₂—OCF₂CF₂CF₂CF₂CF₂CF₂)ₘ₈OCF₂CF₂OCF₂CF₂CF₂CF₂CF₂,

(OCF(CF₃)CF₂)ₘ₉OCF(CF₃)

A is a divalent linking group.

The organic group for A may be a group having a carbon atom. Examples of the organic group for A include divalent hydrocarbon groups (such as alkylene groups, cycloalkylene groups, a phenylene group, and combinations thereof), bonds having carbons atom (such as —C(O)NR⁴—, —C(O)O—, —C(O)—, —NHC(O)O—, and —NHC(O)NR⁴—), and combinations of divalent hydrocarbon groups and bonds (such as —C(O)NR⁴—, —C(O)O—, —C(O)—, —O—, —NR⁴—, —S—, —NHC(O)O—, —NHC(O)NR⁴—, and —SO₂NR⁴—). Here, R⁴ is a hydrogen atom, an alkyl group having 1 to 6 carbon atoms, or a phenyl group.

To facilitate the preparation of the compound (1), A is preferably —(CH₂)ₙ—, —C(O)—, —(CH₂)ₙ—NHC(O)—, —C(O)NH—(CH₂)ₙ—C(O)—, or —C(O)NH—(CH₂)ₙ—. Here, n is an integer of 1 or more. n is an integer of preferably 1 to 10, particularly preferably 1 or 2.

Q¹ is a linear or branched a1+b1 valent linking group. Q² is a linear or branched a2+b2+1 valent linking group.

The organic group for Q¹ preferably has at least one branched point (hereinafter, referred to as “branched point P”) selected from the group consisting of C, N, Si, cyclic structures, and a1+b1 valent organopolysiloxane residues. A specific branched chain bonds to the branched point P. The organic group for Q² preferably has at least one branched point (hereinafter, referred to as “branched Point P′”) selected from the group consisting of C, N, Si, cyclic structures, and a2+b2+1 valent organopolysiloxane residues. A specific branched chain bonds to the branched point P′. Here, the specific branched chain indicates a chain containing a fluorinated organic group (R^{f} or Q^{f}) or a reactive silyl group.

To facilitate the preparation of the compound (1) and provide a surface layer having further enhanced friction resistance, lightfastness, and chemical resistance, the cyclic structure is preferably one selected from the group consisting of 3- to 8-membered aliphatic rings, 3- to 8-membered aromatic rings, 3- to 8-membered heterorings, and condensation rings consisting of two or more of these rings, and is particularly preferably the cyclic structures shown in the formulae below. The cyclic structure may have a substituent such as a halogen atom, an alkyl group (which may have an ethereal oxygen atom between carbon atoms), a cycloalkyl group, an alkenyl group, an allyl group, an alkoxy group, or an oxo group (═O).

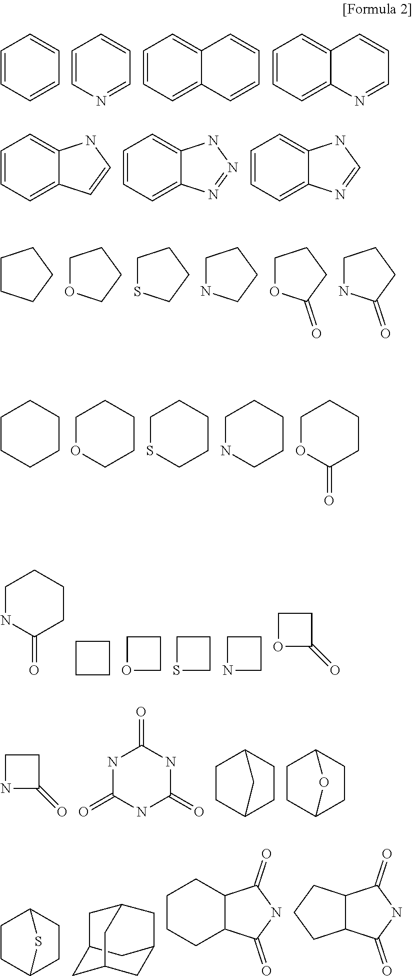

Examples of the a1+b1 valent organopolysiloxane residues or the a2+b2+1 valent organopolysiloxane residues include the following groups. Here, R⁵ in the formula below is a hydrogen atom, an alkyl group, an alkoxy group, or a phenyl group. The alkyl group and the alkoxy group for R⁵ preferably have 1 to 10 carbon atoms, particularly preferably one carbon atom.

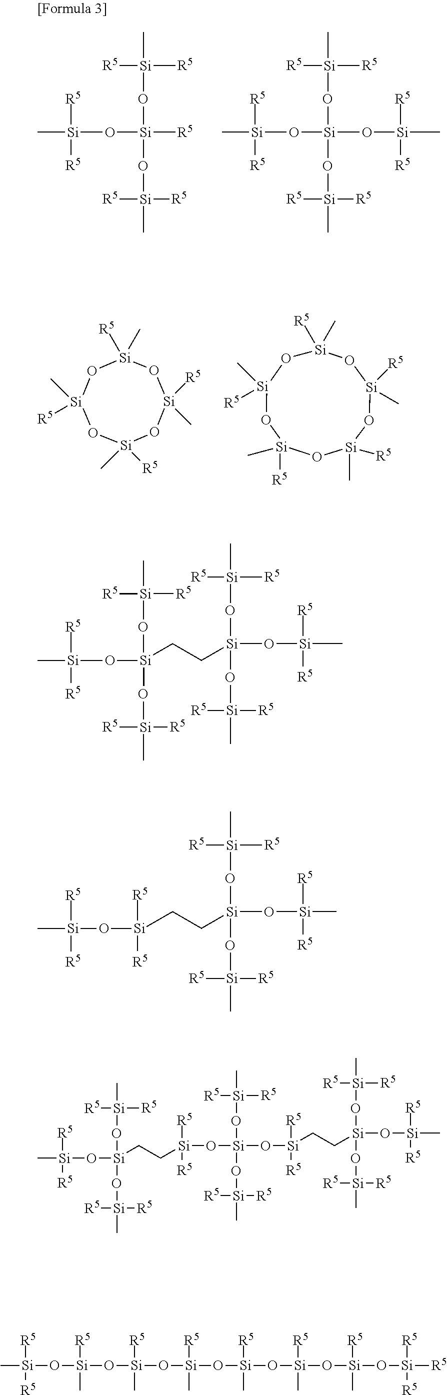

The organic groups for Q¹ and Q² may have at least one bond (hereinafter, referred to as “bond B”) selected from the group consisting of —C(O)NR⁶—, —C(O)O—, —C(O)—, —O—, —NR⁶—, —S—, —NHC(O)O—, —NHC(O)NR⁶—, —SO₂NR⁶—, Si(R⁶)₂—, —OSi(R⁶)₂—, and divalent organopolysiloxane residues. Here, R⁶ is a hydrogen atom, an alkyl group having 1 to 6 carbon atoms, or a phenyl group.

Examples of the divalent organopolysiloxane residues include the groups shown in the following formulae. In the following formulae, R⁷ is a hydrogen atom, an alkyl group, an alkoxy group, or a phenyl group. The alkyl group and the alkoxy group for R⁷ preferably have 1 to 10 carbon atoms, and particularly preferably one carbon atom.

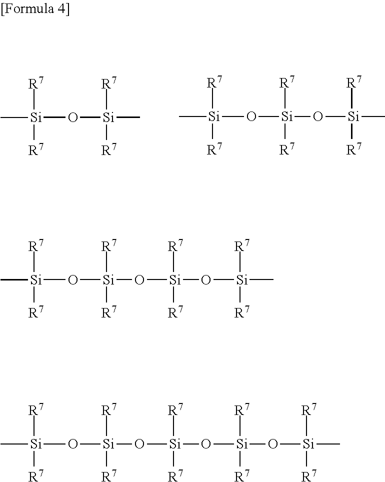

The bond B is preferably at least one bond selected from the group consisting of —C(O)NR⁶—, —C(O)—, and —O— to facilitate the preparation of the compound (1), and is particularly preferably —C(O)NR⁶— or —C(O)— to provide a surface layer having further enhanced lightfastness and chemical resistance.

Examples of Q¹ include a combination of two or more divalent hydrocarbon groups and one or more branched points P, or a combination of two or more hydrocarbon groups, one or more branched points P, and one or more bonds B. Examples of Q² include a combination of two or more divalent hydrocarbon groups and one or more branched points P′, or a combination of two or more hydrocarbon groups, one or more branched points P°, and one or more bonds B.

Examples of the divalent hydrocarbon groups include divalent aliphatic hydrocarbon groups (such as alkylene groups and cycloalkylene groups), and divalent aromatic hydrocarbon groups (such as a phenylene group). The divalent hydrocarbon groups preferably have 1 to 10 carbon atoms, and more preferably 1 to 6 carbon atoms, and particularly preferably 1 to 4 carbon atoms.

To facilitate the preparation of the compound (1A), Q¹ as the combination is preferably a group (g2-1) (where a1=d1+d3 and b1=d2+d4), a group (g2-2) (where a1=e1 and b1=e2), a group (g2-3) (where a1=1 and b1=2), a group (g2-4) (where a1=h1 and b1=h2), or a group (g2-5) (where a1=i1 and b1=i2).

To facilitate the preparation of the compound (1B), Q² as the combination is preferably a group (g2-1) (where a2+1=d1+d3 and b2=d2+d4), a group (g2-2) (where a2+1=e1 and b2=e2), a group (g2-3) (where a2+1=1 and b2=2), a group (g2-4) (where a2+1=h1 and b2=h2), or a group (g2-5) (where a2+1=i1 and b2=i2).

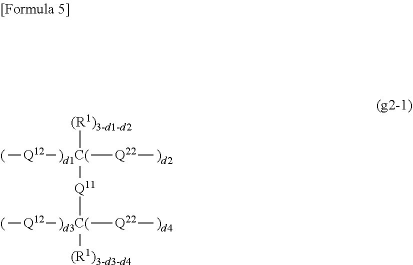

(-Q¹²-)ₑ₁C(R²)₄₋ₑ₁₋ₑ₂(-Q²²-)ₑ₂ (g2-2)

-Q¹³-N(-Q²³-)₂ (g2-3)

(-Q¹⁴-)ₕ₁Z(-Q²⁴-)ₕ₂ (g2-4)

(-Q¹⁵-)ᵢ₁Si(R³)₄₋ᵢ₁₋ᵢ₂(-Q²⁵-)ᵢ₂ (g2-5)

In the formulae (g2-1) to (g2-5), the Q¹², Q¹³, Q¹⁴, and Q¹⁵ sides are linked to a nitrogen atom of [(R^{f}-A-)₂N—] or —N(R¹⁰)₁₋ₐ₃(-A-R^{f})₃—, and the Q²², Q²³, Q²⁴, and Q²⁵ sides are linked to T; Q¹¹ is a single bond, —O—, an alkylene group, or a group having —O— between carbon atoms of an alkylene group having two or more carbon atoms; Q¹² is a single bond, —C(O)—, or an alkylene group, and when Q¹ or Q² has two or more Q¹², the two or more Q¹² may be the same or different; Q¹³ is an alkylene group; Q¹⁴ is Q¹² when the atom in Z to which Q¹⁴ is bonded is a carbon atom, and is Q¹³ when the atom in Z to which Q¹⁴ is bonded is a nitrogen atom, and when Q¹ or Q² has two or more Q¹⁴, the two or more Q¹⁴ may be the same or different; Q¹⁵ is an alkylene group, and when Q¹ or Q² has two or more Q¹⁵, the two or more Q¹⁵ may be the same or different; Q²² is an alkylene group, a group having —C(O)NH—, —C(O)—, or —O— between carbon atoms of an alkylene group having two or more carbon atoms, a group having —C(O)NH—, —C(O)—, or —O— in a terminal of an alkylene group not linked to Si, or a group having —C(O)NH—, —C(O)—, or —O— between carbon atoms of an alkylene group having two or more carbon atoms and having —C(O)NH—, —C(O)—, or —O— in a terminal not linked to Si, and two or more Q² be the same or different; Q²³ is an alkylene group or a group having —C(O)NH—, —C(O)—, or —O— between carbon atoms of an alkylene group having two or more carbon atoms, and two Q²³ may be the same or different; Q²⁴ is Q²² when the atom in Z to which Q²⁴ is bonded is a carbon atom, and is Q²³ when the atom in Z to which Q²⁴ is bonded is a nitrogen atom, and two or more Q²⁴ may be the same or different; Q²⁵ is an alkylene group or a group having —C(O)NH—, —C(O)—, or —O— between carbon atoms of an alkylene group having two or more carbon atoms, and two or more Q²⁵ may be the same or different; Z is a group having a a1+b1 valent or a2+b2+1 valent cyclic structure having a carbon atom or a nitrogen atom directly bonded by Q¹⁴ and a carbon atom or a nitrogen atom directly bonded Q²⁴; R¹ is a hydrogen atom or an alkyl group, and when Q¹ or Q² has two or more R¹, the two or more R¹ may be the same or different; R² is a hydrogen atom or an alkyl group; R³ is an alkyl group; d1 is an integer of 0 to 3, preferably 1 or 2, d2 is an integer of 0 to 3, preferably 1 or 2, d1+d2 is an integer of 1 to 3, d3 is an integer of 0 to 3, preferably 1 or 2, d4 is an integer of 0 to 3, preferably 1 or 2, d3+d4 is an integer of 1 to 3, d1+d3 is an integer of 1 to 4, preferably 2 or 3, d2+d4 is an integer of 2 to 5, preferably 2 to 4, e1 is 1 or 2, e2 is 2 or 3, e1+e2 is 3 or 4, h1 is an integer of 1 or more, preferably 1 or 2, h2 is an integer of 2 or more, preferably 2 or 3, i1 is 1 or 2, i2 is 2 or 3, and i1+i2 is 3 or 4.

To facilitate the preparation of the compound (1) and provide a surface layer having further enhanced friction resistance, lightfastness and chemical resistance, the alkylene groups for Q¹¹, Q¹², Q¹³, Q¹⁴, Q¹⁵, Q²², Q²³, Q²⁴, and Q²⁵ preferably have 1 to 10 carbon atoms, more preferably have 1 to 6 carbon atoms, and particularly preferably have 1 to 4 carbon atoms. Here, when a specific bond is included between carbon atoms, the lower limit value of the number of carbon atoms in the alkylene group is 2.

Examples of the cyclic structure for Z include those listed above, and the cyclic structure also have the same preferred forms as those described above. Because Q¹⁴ or Q²⁴ directly bonds to the cyclic structure for Z, an alkylene group is not linked to the cyclic structure, and thus Q¹⁴ or Q²⁴ is not linked to the alkylene group, for example.

To facilitate the preparation of the compound (1), the alkyl groups for R¹, R², and R³ preferably have 1 to 6 carbon atoms, more preferably have 1 to 3 carbon atoms, and particularly preferably have 1 to 2 carbon atoms.

To facilitate the preparation of the compound (1), and provide a surface layer having further enhanced friction resistance and fingerprint marks removability, h1 is preferably 1 to 6, more preferably 1 to 4, still more preferably 1 or 2, particularly preferably 1.

To facilitate the preparation of the compound (1) and provide a surface layer having further enhanced friction resistance and fingerprint marks removability, h2 is preferably 2 to 6, more preferably 2 to 4, particularly preferably 2 or 3.

Examples of other forms of Q¹ include a group (g2-6) (where a1=d1+d3 and b1=k in total), a group (g2-7) (where a1=e1 and b1=k in total), a group (g2-8) (where a1=1 and b1=k in total), a group (g2-9) (where a1=h1 and b1=k in total), or a group (g2-10) (where a1=i1 and b1=k in total).

Examples of other forms of Q² include a group (g2-6) (where a2+1=d1+d3 and b2=k in total), a group (g2-7) (where a2+1=e1 and b2=k in total), a group (g2-8) (where a2+1=1 and b2=k in total), a group (g2-9) (where a2+132 h1 and b2=k in total), or a group (g2-10) (where a2+1=i1 and b2=k in total).

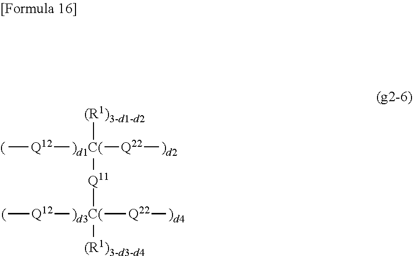

(-Q¹²-)ₑ₁C(R²)₄₋ₑ₁₋ₑ₂(-Q²²-G)ₑ₂ (g2-7)

-Q¹³-N(-Q²³-G)₂ (g2-8)

(-Q¹⁴-)ₕ₁Z(-Q²⁴-G)ₕ₂ (g2-9)

(-Q¹⁵-)ᵢ₁Si(R³)₄₋ᵢ₁₋ᵢ₂(-Q²⁵-G)ᵢ₂ (g2-10)

In the formulae (g2-6) to (g2-10), the Q¹²_{, Q}¹³, Q¹⁴, and Q¹⁵ sides are linked to a nitrogen atom of [(R^{f}-A-)₂N—] or —N(R¹⁰)₁₋ₐ₃(-A-R^{f})ₐ₃— and G links to T (where G is a group (g3) and two or more G included in Q¹ or Q² may be the same or different); and signs other than G are the same as those defined in the formulae (g2-1) to (g2-5).

—Si(R⁸)₃₋ₖ(-Q³-)ₖ (g3)

In the formula (g3), Si links to Q²², Q²³, Q²⁴, and Q²⁵, and Q³ links to T; R⁸ is an alkyl group; Q³ is an alkylene group, a —C(O)NH—, —C(O)—, or —O— between carbon atoms of an alkylene group having two or more carbon atoms, or —(OSi(R⁹)₂)ₚ—O—; two or more Q³ may be the same or different; k is 2 or 3; R⁹ is an alkyl group, a phenyl group, or an alkoxy group; two R⁹ may be the same or different; p is an integer of 0 to 5, and when p is 2 or more, two or more (OSi(R⁹)₂) may be the same or different.

To facilitate the preparation of the compound (1) and provide a surface layer having further enhanced friction resistance, lightfastness, and chemical resistance, the alkylene group for Q³ preferably has 1 to 10 carbon atoms, more preferably has 1 to 6 carbon atoms, and particularly preferably has 1 to 4 carbon atoms. If a specific bond is included between carbon atoms, the lower limit value of the number of carbon atoms in the alkylene group is 2.

To facilitate the preparation of the compound (1), the alkyl group for R⁸ preferably has 1 to 6 carbon atoms, more preferably has 1 to 3 carbon atoms, and particularly preferably has 1 to 2 carbon atoms.

To facilitate the preparation of the compound (1), the alkyl group for R⁹ preferably has 1 to 6 carbon atoms, more preferably has 1 to 3 carbon atoms, and particularly preferably has 1 to 2 carbon atoms.

To provide high storage stability of the compound (1), the alkoxy group for R⁹ preferably has 1 to 6 carbon atoms, more preferably has 1 to 3 carbon atoms, and particularly preferably has 1 to 2 carbon atoms.

p is preferably 0 or 1.

T is —Si(R)_{3-c}(L)_{c}, and is a reactive silyl group.

To facilitate the preparation of the compound (1), the alkyl group for R preferably has 1 to 6 carbon atoms, more preferably has 1 to 3 carbon atoms, and particularly preferably has 1 to 2 carbon atoms.

The hydrolyzable group for L is a group which is formed into a hydroxyl group through a hydrolysis reaction. In other words, Si-L where L is a hydrolyzable group is formed into a silanol group (Si—OH) through a hydrolysis reaction. The silanol group forms an Si—O—Si bond through a dehydration condensation reaction between molecules. The silanol group forms a chemical bond (substrate —O—Si) through a dehydration condensation reaction with a hydroxyl group (substrate —OH) on the surface of the substrate.

Examples of the hydrolyzable group include an alkoxy group, an aryloxy group, halogen atoms, an acyl group, an acyloxy group, and an isocyanate group. The alkoxy group is preferably an alkoxy group having 1 to 6 carbon atoms. The aryloxy group is preferably an aryloxy group having 3 to 10 carbon atoms. The aryl group in the aryloxy group include heteroaryl groups. The halogen atom is preferably a chlorine atom. The acyl group is preferably an acyl group having 1 to 6 carbon atoms. The acyloxy group is preferably an acyloxy group having 1 to 6 carbon atoms.

To facilitate the preparation of the compound (1), L is preferably an alkoxy group and halogen atoms. L is preferably an alkoxy group having 1 to 4 carbon atoms because it generates a small amount of outgas during application of the coating liquid and provides high storage stability of the compound (1). L is particularly preferably an ethoxy group if the compound (1) should have long-term storage stability. L is particularly preferably a methoxy group if the reaction time after coating is reduced.

c is particularly preferably 3 to provide stronger adhesion between the surface layer and the substrate.

A plurality of T in the compound (1) may be the same or different. To facilitate the preparation of the compound (1), these Ts are preferably the same group.

Examples of the compound (1) include compounds represented by the following formulae. The compounds represented by the following formulae are preferred because these are easy to industrially produce, easy to handle, and provide a surface layer having high water/oil repellency, friction resistance, fingerprint marks removability, lubrication, chemical resistance, lightfastness, and chemical resistance, especially high lightfastness. R^{f} or Q^{f} in the compounds represented by the following formulae are the same as defined as R^{f} or Q^{f} in the formula (1) described above, and their preferred forms are also the same as described above as above.

Examples of the compound (1A) where Q¹ is a group (g2-1) include compounds represented by the following formulae:

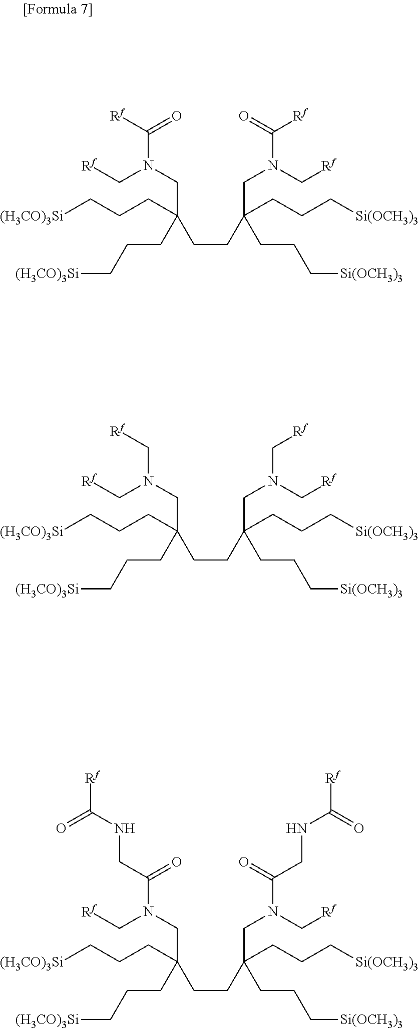

Examples of the compound (1A) where Q¹ is a group (g2-2) include compounds represented by the following formulae:

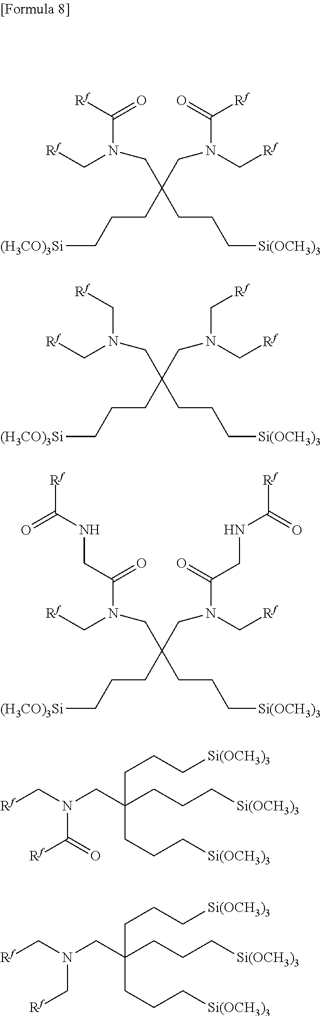

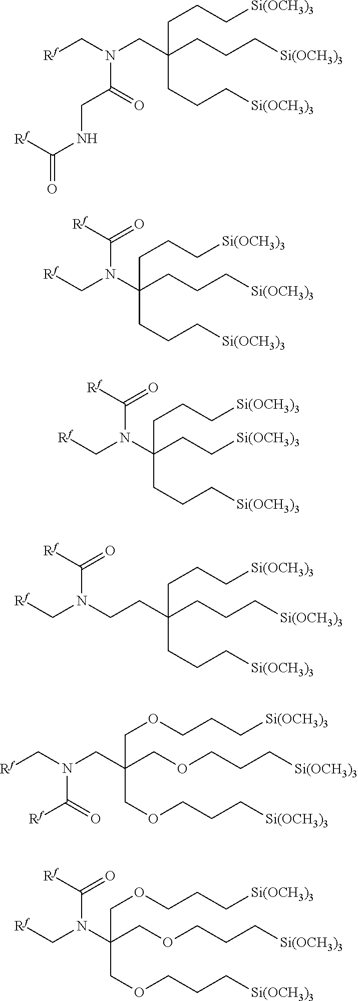

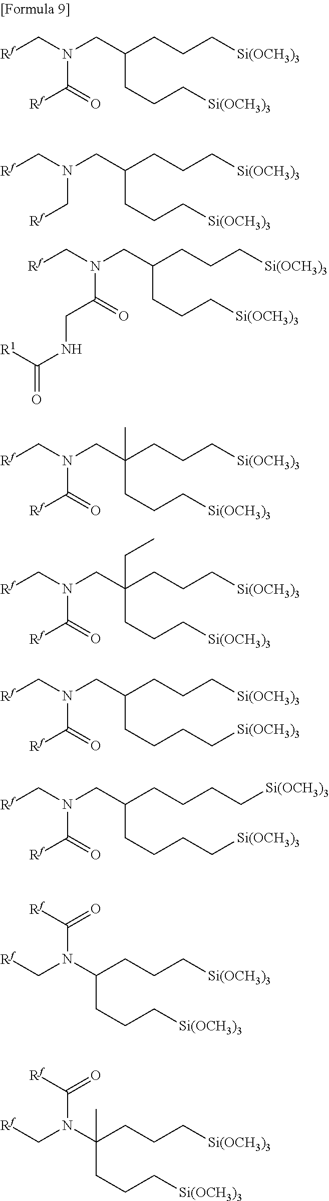

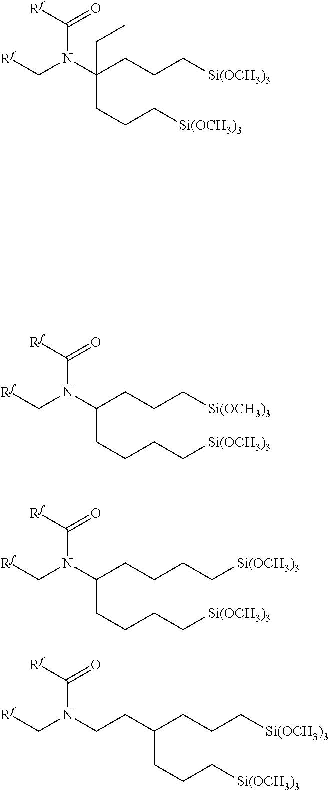

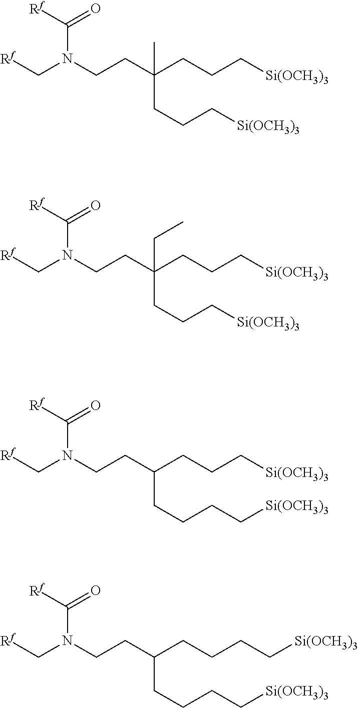

Examples of the compound (1A) where Q¹ is a group (g2-3) include compounds represented by the following formulae:

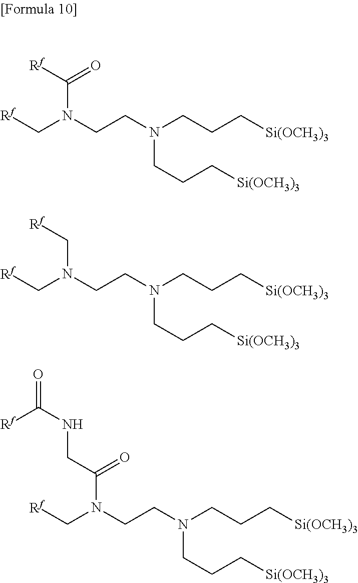

Examples of the compound (1A) where Q¹ is a group (g2-4) include compounds represented by the following formulae:

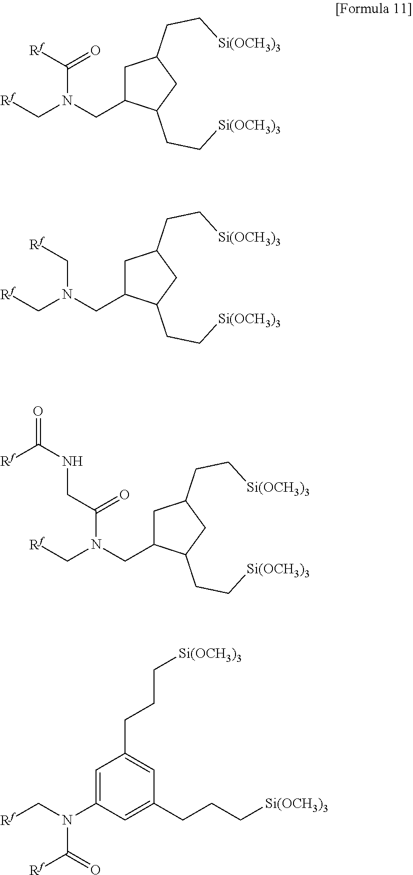

Examples of the compound (1A) where Q¹ is a group (g2-7) include compounds represented by the following formulae:

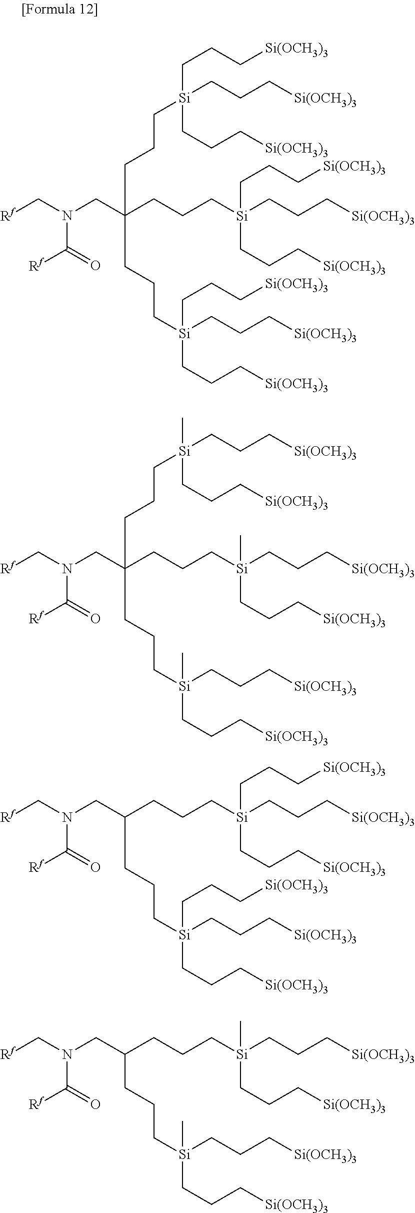

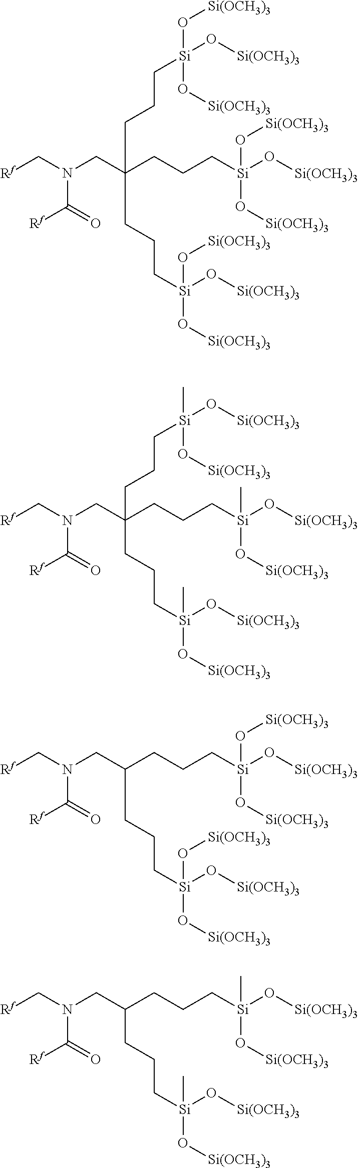

Examples of the compound (1B) where Q² is a group (g2-1) include compounds represented by the following formulae:

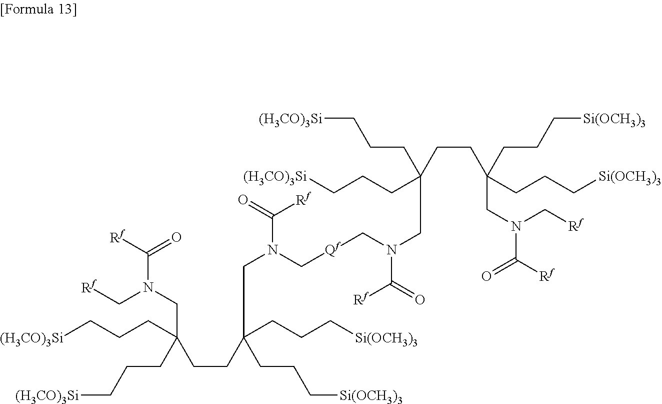

Examples of the compound (1B) where Q² is a group (g2-2) include compounds represented by the following formulae:

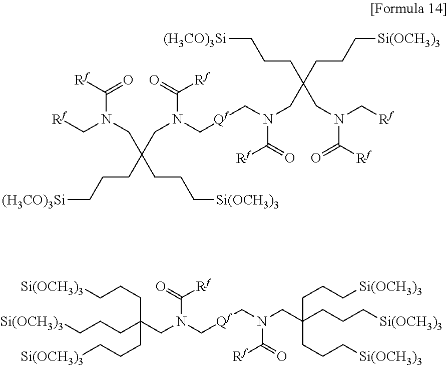

Examples of the compound (1B) where Q² is a group (g2-3) include compounds represented by the following formulae:

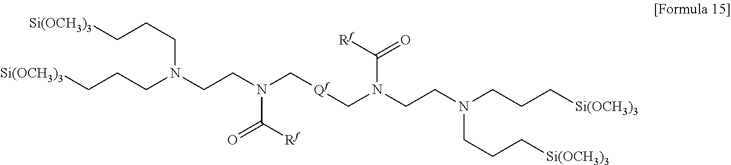

Examples of the compound (1B) where Q² is a group (g2-4) include compounds represented by the following formulae:

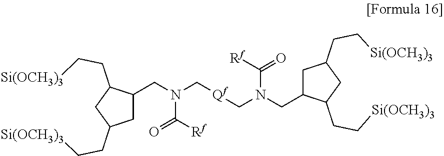

Examples of the compound (1B) where Q² is a group (g2-7) include compounds represented by the following formulae:

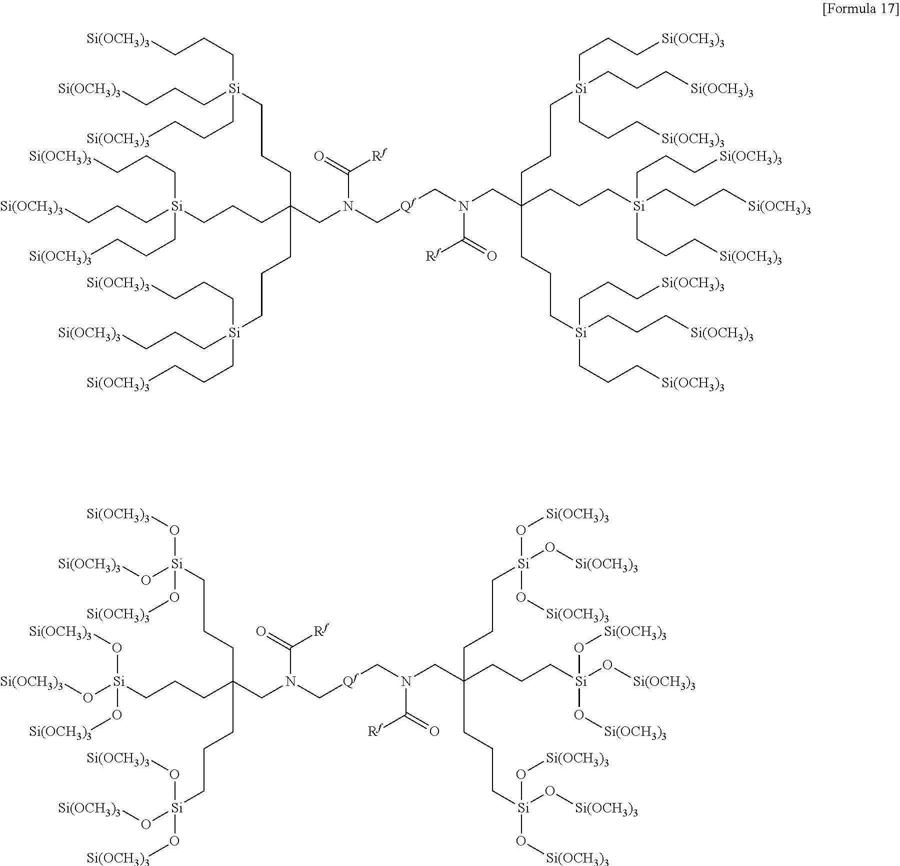

### (Method of Preparing Compound (1A) and Compound (1B))

The compound (1A) can be prepared by a method of subjecting the compound (2A) and the compound (3a) or compound (3b) to a hydrosilylation reaction, for example. The compound (1B) can be prepared by a method of subjecting the compound (2B) and the compound (3a) or compound (3b) to a hydrosilylation reaction, for example.

[(R^{f}-A-)₂N-]ₐ₁Q¹⁰[-CH═CH₂]_{b1} (2A)

[CH₂═CH—]_{b2}[(R^{f}-A-)₂N-]ₐ₂Q²⁰-N(-A-Q^{f}-A-N(-A-R^{f})-Q²⁰[-N(-A-R^{f})₂]ₐ₂[—CH═CH₂]_{b2} (2B)

In the formula (2A), Q¹⁰ is a a1+b1 valent organic group, and signs other than Q¹⁰ are the same as those defined in the formula (1A). In the formula (2B), Q²⁰ is a a2+b2+1 valent organic group, and two Q²⁰ may be the same or different; and signs other than Q²⁰ are the same as those defined in the formula (1B).

Q¹⁰[-CH═CH₂]_{b1} s hydrosilylated into Q¹ in the compound (1A). Examples of Q¹⁰ include the same groups as those for Q¹, and preferred forms are also the same as described above. Q²⁰[-CH═CH₂]_{b2} is hydrosilylated into Q² in the compound (1B). Examples of Q²⁰ include the same groups as those for Q², and preferred forms are also the same as described above.

In the compound (2B), the two monovalent groups linked through Q^{f} may be the same or different. In other words, at least one of A, Q²⁰, R^{f}, a2, and b2 may be different in the two groups represented by [CH₂═CH—]_{b2}[(R^{f}-A-)₂N-]ₐ₂Q²⁰-N(-A-R^{f})-A- included in the compound (2B).

To facilitate the preparation of the compound (2B), the compound (2B) preferably has two identical monovalent groups linked through Q^{f}. The compound (2B) having two identical monovalent groups linked through Q^{f} is represented by the following formula (2BX) below:

{[CH₂═CH—]_{b2}[(R¹-A-)₂N-]ₐ₂Q²⁰-N(-A-R^{f})-A-}₂Q^{f} (2BX)

HSi(R)_{3-c}(L)_{c} (3a)

HSi(R⁸)₃₋ₖ[—(OSi(R⁹)₂)ₚ—O—Si(R)_{3-c}(L)_{c}]ₖ (3b)

Here, the signs in the formulae (3a) and (3b) are the same as those defined in the formulae (1) and (g3). The compound (3b) can be prepared by the method according to the specification of Japanese Patent Application No. 2018-085493, for example.

To facilitate the preparation of the compound (1A), Q¹⁰[-CH═CH₂]_{b1} is preferably a group (g4-1) (where a1=d1+d3 and b1=d2+d4), a group (g4-2) (where a1=e1 and b1=e2), a group (g4-3) (where a1=1 and b1=2), a group (g4-4) (where a1=h1 and b1=h2), or a group (g4-5) (where a1=i1 and b1=i2).

To facilitate the preparation of the compound (1B), Q²⁰[-CH═CH₂]_{b2} is preferably a group (g4-1) (where a2+1=d1+d3 and b2=d2+d4), a group (g4-2) (where a2+1=e1 and b2=e2), a group (g4-3) (where a2+1=1 and b2=2), a group (g4-4) (where a2+1=h1 and b2=h2), or a group (g4-5) (where a2+1=i1 and b2=i2).

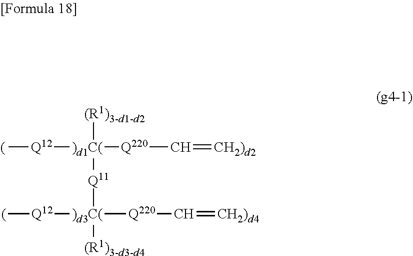

(-Q¹²-)ₑ₁C(R²)₄₋ₑ₁₋ₑ₂(-Q²²⁰-CH═CH₂)ₑ₂ (g4-2)

-Q¹³-N(-Q²³⁰-CH═CH₂)₂ (g4-3)

(-Q¹⁴-)ₕ₁Z(-Q²⁴⁰-CH═CH₂)ₕ₂ (g4-4)

(-Q¹⁵-)ᵢ₁Si(R³)₄₋ᵢ₁₋ᵢ₂(-Q²⁵⁰-CH═CH₂)ᵢ₂ (g4-4)

where Q²²⁰ is an alkylene group, a group having —C(O)NH—, —C(O)—, or —O— between carbon atoms of a alkylene group having two or more carbon atoms, a group having —C(O)NH—, —C(O)—, or —O— in the terminal of an alkylene group not linked to Si, or a group having —C(O)NH—, —C(O)—, or —O— between carbon atoms of an alkylene group having two or more carbon atoms and having —C(O)NH—, —C(O)—, or —O— in the terminal not linked to Si, and two or more Q²²⁰ may be the same or different; Q²³⁰ is an alkylene group or a group having —C(O)NH—, —C(O)—, or —O— between carbon atoms of an alkylene group having two or more carbon atoms, and two or more Q²³⁰ may be the same or different; Q²⁴⁰ is Q²²⁰ when an atom in Z to which Q²⁴⁰ is bonded is a carbon atom, and is Q²³⁰ when an atom in Z to which Q²⁴⁰ is bonded is a nitrogen atom, and two or more Q²⁴⁰ may be the same or different; Q²⁵⁰ is an alkylene group or a group having —C(O)NH—, —C(O)—, or —O— between carbon atoms of an alkylene group having two or more carbon atoms, and two or more Q²⁵⁰ may be the same or different; and signs other than Q²²⁰, Q²³⁰, Q²⁴⁰, and Q²⁵⁰ are the same as those defined in the formulae (g2-1) to (g2-5).

Q²²⁰-CH═CH₂ is hydrosilylated into Q²² in the compound (1). Examples of Q²²⁰ include the same groups as those for Q²², and preferred forms are also the same as described above.

Q²³⁰-CH═CH₂ is hydrosilylated into Q²³ in the compound (1). Examples of Q²³⁰ include the same groups as those for Q²³, and preferred forms are also the same as described above.

Q²⁴⁰-CH═CH₂ is hydrosilylated into Q²⁴ in the compound (1). Examples of Q²⁴⁰ include the same groups as those for Q²⁴, and preferred forms are also the same as described above.

Q²⁵⁰-CH═CH₂ is hydrosilylated into Q²⁵ in the compound (1). Examples of Q²⁵⁰ include the same groups as those for Q²⁵, and preferred forms are also the same as described above.

Examples of other forms of Q¹⁰[-CH═CH₂]_{b1} include a group (g4-6) (where a1=d1+d3 and b1=k in total), a group (g4-7) (where a1=e1 and b1=k in total), a group (g4-8) (where a1=1 and b1 =k in total), a group (g4-9) (where a1=h1 and b1=k in total), or a group (g4-10) (where a1=i1 and b1=k in total).

Examples of other forms of Q²⁰[-CH═CH₂]_{b2} include a group (g4-6) (where a2+1=d1+d3 and b2=k in total), a group (g4-7) (where a2+1=e1 and b2=k in total), a group (g4-8) (where a2+1=1 and b2=k in total), a group (g4-9) (where a2+1=h1 and b2=k in total), or a group (g4-10) (where a2+1=i1 and b2=k in total).

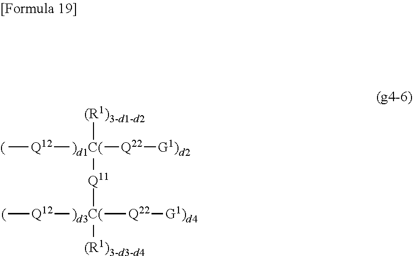

(-Q¹²-)ₑ₁C(R₂)₄₋ₑ₁₋ₑ₂(-Q²²-G¹)ₑ₂ (g4-7)

-Q¹³-N(-Q²³-G¹)₂ (g4-8)

(-Q¹⁴-)ₕ₁Z(-Q²⁴-G¹)ₕ₂ (g4-9)

(-Q¹⁵-)ᵢ₁Si(R³)₄₋ᵢ₁₋ᵢ₂(-Q²⁵-G¹)ᵢ₂ (g4-10)

Here, G¹ is a group (g5), two or more G¹ included in Q¹⁰[-CH═CH₂]_{b1} or Q²⁰[-CH═CH₂]_{b2} may be the same or different, and signs other than G¹ are the same as those defined in the formulae (g2-1) to (g2-5).

—Si(R⁸)₃₋ₖ(-Q³⁰-CH═CH₂)ₖ (g5)

where Q³⁰ is an alkylene group or a group having —C(O)NH—, —C(O)—, or —O— between carbon atoms of an alkylene group having two or more carbon atoms; two or more Q³⁰ may be the same or different; and signs other than Q³⁰ are the same as those defined in the formula (g3).

Q³⁰-CH═CH₂ is hydrosilylated into Q³ in the group (g3). Examples of Q³⁰ include the same groups as those for Q³ (excluding —(OSi(R⁹)₂)ₚ—O—), and preferred forms are also the same as described above.

### (Method of Preparing Compound (2A) and Compound (2B))

The compound (2A) can be prepared by the following procedure, for example.

A compound (4A) and a compound (5a) are amidated to yield a compound (6A).

[H₂N-]ₐ₁Q¹⁰[-CH═CH₂]_{b1} (4A)

R^{f}—C(O)—X (5a)

[R^{f}—C(O)—NH-]ₐ₁Q¹⁰[-CH═CH₂]_{b1} (6A)

where X is a halogen atom, an alkoxy group, or a hydroxyl group, and signs other than X are the same as those defined in the formula (2A).

The compound (4A) is available as a commercial compound. Alternately, the compound (4A) can be prepared by the methods according to WO2017/187775 and WO2019/039186, for example.

The compound (5a) can be prepared by the methods according to WO2009/008380, WO2013/121984, WO2013/121986, WO2015/087902, WO2017/038830, WO2017/038832, WO2018/143433, and WO2018/216630, for example.

The compound (6A) where Q¹⁰[-CH═CH₂]_{b1} is a group (g4-1) can be prepared by the method according to WO2017/187775 (where d1 and d3=1 and d2 and d4=2), for example.

The compound (6A) where Q¹⁰[-CH═CH₂]_{b1} is a group (g4-2) can be prepared by the methods according to WO2017/187775 (where e1=2 and e2=2), WO2017/038830 (where e1=1 and e2=3), WO2019/039226 (where e1=1, e2=2, and R² is a hydrogen atom or an alkyl group), for example.

The compound (6A) where Q¹⁰[-CH═CH₂]_{b1} is a group (g4-3) can be prepared by the method according to WO2017/038832, for example.

The compound (6A) where Q¹⁰[-CH═CH₂]_{b1} is a group (g4-4) can be prepared by the method according to WO2019/039186, for example.

The compound (6A) where Q¹⁰[-CH═CH₂]_{b1} is any one of the groups (g4-7) to (g4-9) can be prepared by the method according to WO2019/163282, for example.

The compound (6A) is reacted with a reducing agent (such as sodium borohydride or lithium aluminum hydride) to yield a compound (7A).

[R^{f}—CH₂—NH-]ₐ₁Q¹⁰[-CH═CH₂]_{b1} (7A)

where signs in the formula (7A) are the same as those defined in the formula (2A).

The compound (7A) and the compound (5a) are amidated to yield a compound (2Aa).

[(R^{f}—CH₂—)(R^{f}—C(O)—)N-]ₐ₁Q¹⁰[-CH═CH₂]_{b1} (2Aa)

Here, signs in the formula (2Aa) are the same as those defined in the formula (2A).

The compound (2Aa) may be reacted with a reducing agent (such as sodium borohydride or lithium aluminum hydride) to yield a compound (2Ab).

[(R^{f}—CH₂—)₂N-]ₐ₁Q¹⁰[-CH═CH₂]_{b1} (2Ab)

where signs in the formula (2Ab) are the same as those defined in the formula (2A).

If a2 is 1 or more, the compound (2B) can be prepared by the following procedure, for example.

The compound (4B) and the compound (5a) are amidated to yield a compound (6B):

[H₂N-]ₐ₂₊₁Q²[-CH═CH₂]_{b2} (4B)

R^{f}—C(O)—X (5a)

[R^{f}—C(O)—NH—]ₐ₂[H₂N-]Q²⁰[-CH═CH₂]_{b2} (6B)

where X is a halogen atom, an alkoxy group, or a hydroxyl group, and signs other than X are the same as those defined in the formula (2B).

Examples of the compound (4B) include the same as those in the compound (4A).

The compound (6B) is reacted with a compound (5b) to yield a compound (6B′):

X—C(O)-Q^{f}-C(O)—X (5b)

[CH₂═CH—]_{b2}[R^{f}—C(O)—NH-]ₐ₂Q²⁰-NH—C(O)-Q^{f}-C(O)—NH-Q²⁰[-NH—C(O)—R^{f}]ₐ₂[—CH═CH₂]_{b2} (6B′)

where X is a halogen atom, an alkoxy group, or a hydroxyl group, and signs other than X are the same as those defined in the formula (2B).

The compound (5b) can be prepared by the same method as that in the compound (5a).

The compound (6B′) is reacted with a reducing agent (such as sodium borohydride or lithium aluminum hydride) to yield a compound (7B):

[CH₂═CH—]_{b2}[R^{f}—CH₂—NH-]ₐ₂Q^{20-NH—CH}₂-Q^{f}-CH₂—NH-Q²⁰[-NH—CH₂—R^{f}]ₐ₂[—CH═CH₂]_{b2} (7B)

where signs in the formula (7B) are the same as those defined in the formula (2B).

The compound (7B) and the compound (5a) are amidated to yield a compound (2Ba):

[CH₂═CH—]_{b2}[(R^{f}—CH₂—)(R^{f}—C(O)—)N-]ₐ₂Q²⁰-N(—C(O)—R^{f})—CH₂-Q^{f}-CH₂—N(—C(O)—R^{f})-Q²⁰[-N(—C(O)—R^{f})(—CH₂—R^{f})]ₐ₂[—CH═CH₂]_{b2} (2Ba)

where signs in the formula (2Ba) are the same as those defined in the formula (2B):

The compound (2Ba) may be reacted with a reducing agent (such as sodium borohydride or lithium aluminum hydride) to yield a compound (2Bb):

[CH₂═CH—]_{b2}[(R^{f}—CH₂—)₂N-]ₐ₂Q²⁰-N(—CH₂—R^{f})—CH₂-Q^{f}-CH₂—N(—CH₂—R^{f})-Q²⁰[-N(—CH₂—R^{f})₂]ₐ₂[—CH═CH₂]_{b2} (2Bb).

where signs in the formula (2Bb) are the same as those defined in the formula (2B).

If a2 is 0, the compound (2B) can be prepared by the following procedure, for example.

A compound (4C) and the compound (5b) are amidated to yield a compound (6C):

H₂N-Q²⁰[-C═CH₂]_{b2} (4C)

X—C(O)-Q^{f}-C(O)—X (5b)

[CH₂═CH—]_{b2}Q²⁰-NH—C(O)-Q^{f}-C(O)—NH-Q²⁰[-CH═CH₂]_{b2} (6C)

where X is a halogen atom, an alkoxy group, or a hydroxyl group, and signs other than X are the same as those defined in the formula (2B).

The compound (6C) is reacted with a reducing agent (such as sodium borohydride or lithium aluminum hydride) to yield a compound (7C):

[CH₂═CH-]_{b2}Q²⁰-NH—CH₂—Q^{f}-CH₂—NH-Q²⁰[-CH═CH₂]_{b2} (7C)

The compound (7C) and the compound (5a) are amidated to yield a compound (2Bc):

[CH₂═CH-]_{b2}Q²⁰-N(—C(O)—R^{f})—CH₂-Q^{f}-CH₂—N(—C(O)—R^{f})-Q²⁰[-CH═CH₂]_{b2} (2Bc)

where signs in the formula (2Bc) are the same as those defined in the formula (2B).

The compound (2Bc) may be reacted with a reducing agent (such as sodium borohydride or lithium aluminum hydride) to yield a compound (2Bd):

[CH₂═CH-]_{b2}Q²⁰-N(—CH₂—R^{f})—CH₂-Q^{f}-CH₂—N(—CH₂—R^{f})-Q²⁰[-CH═CH₂]_{b2} (2Bd)

where signs in the formula (2Bd) are the same as those defined in the formula (2B).

The reason why the compound (1) described above enables formation of a surface layer having high friction resistance and fingerprint marks removability even if the compound (1) has a fluorinated organic group having a shorter chain will be described as follows.

In the fluorinated compound according to WO2017/187775 having a plurality of fluorinated organic groups (fluoropolyether chains), the distance between these fluorinated organic groups is large, resulting in a low density of the fluorinated organic group in the surface layer. For this reason, if an improvement in slip resistance of the surface layer is attempted by reducing the chain length of the fluorinated organic group, the friction resistance and fingerprint marks removability of the surface layer tend to be reduced.

In contrast, in the compound (1) according to the present invention, two fluorinated organic groups (R^{f} and R^{f}, or R^{f} and Q^{f}) bond to a branch of an N atom through the group A, and thus these two fluorinated organic groups are close to each other. For this reason, the distance between the fluorinated organic groups is small, resulting in high density of the fluorinated organic group in the surface layer. For this reason, a surface layer having high friction resistance and fingerprint marks removability can be formed even if the chain length of the fluorinated organic group is reduced.

### [Fluorinated Compound-Containing Composition]

The fluorinated compound-containing composition according to the present invention (hereinafter, referred to as “the present composition”) comprises at least one type of compound (1), and other fluorinated compound.

Examples of other fluorinated compound include fluorinated compounds yielded as by-products during the production process of the compound (1) (hereinafter, also referred to as “by-product fluorinated compound”), and known fluorinated compounds used in the same applications as those of the compound (1).

Other fluorinated compound is preferably a compound which is less likely to reduce the properties of the compound (1).

Examples of the by-product fluorinated compounds include an unreacted compound (2A) or compound (2B), and fluorinated compounds having allyl groups partially isomerized to inner olefins during hydrosilylation in the preparation of the compound (1).

Examples of the known fluorinated compounds include fluorinated compounds commercially available as surface treatment agents. If the present composition contains a known fluorinated compound, it may demonstrate a new effect such as compensation for the properties of the compound (1).

The content of the compound (1) is preferably 60% by mass or more and less than 100% by mass, more preferably 70% by mass or more and less than 100% by mass, particularly preferably 80% by mass or more and less than 100% by mass in the present composition.

The content of other fluorinated compound is preferably more than 0% by mass and 40% by mass or less, more preferably more than 0% by mass and 30% by mass or less, particularly preferably more than 0% by mass and 20% by mass or less in the present composition.

The total of the contents of the compound (1) and other fluorinated compound is preferably 80 to 100% by mass, particularly preferably 85 to 100% by mass in the present composition.

If the contents of the compound (1) and other fluorinated compound are within the range above, the resulting surface layer has further enhanced initial water/oil repellency, friction resistance, fingerprint marks removability, lightfastness, and chemical resistance.

The present composition may contain components other than the compound (1) and other fluorinated compound in the range not impairing the effects of the present invention.

Examples of the other components include byproducts generated during the production processes of the compound (1) and the known fluorinated compounds (excluding the by-product fluorinated compounds), and compounds inevitably generated during the production, such as unreacted raw materials.

Examples of the other components also include additives such as acid catalysts and basic catalysts which accelerate hydrolysis and condensation reaction of the hydrolyzable silyl group. Examples of the acid catalysts include hydrochloric acid, nitric acid, acetic acid, sulfuric acid, phosphoric acid, sulfonic acid, methanesulfonic acid, and p-toluenesulfonic acid. Examples of the basic catalysts include sodium hydroxide, potassium hydroxide, and ammonia.

The content of the other components is preferably 0 to 9.999% by mass, particularly preferably 0 to 0.99% by mass in the present composition.

### [Coating Liquid]

The coating liquid according to the present invention (hereinafter, also referred to as “the present coating liquid”) comprises the compound (1) or the present composition, and a liquid medium. The present coating liquid may be a solution or may be a dispersion solution.

The liquid medium is preferably an organic solvent. The organic solvent may be a fluorinated organic solvent, may be a non-fluorinated organic solvent, or may contain both solvents.

Examples of the fluorinated organic solvent include fluorinated alkanes, fluorinated aromatic compounds, fluoroalkylethers, fluorinated alkylamines, and fluoroalcohols.

Preferred fluorinated alkanes are compounds having 4 to 8 carbon atoms. Examples of commercial products thereof include C₆F₁₃H (manufactured by AGC Inc., ASAHIKLIN (registered trademark) AC-2000), C₆F₁₃C₂H₅ (manufactured by AGC Inc., ASAHIKLIN (registered trademark) AC-6000), and C₂F₅CHFCHFCF₃ (manufactured by The Chemours Company, Vertrel (registered trademark) XF).

Examples of the fluorinated aromatic compounds include hexafluorobenzene, trifluoromethylbenzene, perfluorotoluene, and bis(trifluoromethyl)benzene.

Preferred fluoroalkylethers are compounds having 4 to 12 carbon atoms. Examples of commercial products thereof include CF₃CH₂OCF₂CF₂H (manufactured by AGC Inc., ASAHIKLIN (registered trademark) AE-3000), C₄F₉OCH₃ (manufactured by 3M Company, Novec (registered trademark) 7100), C₄F₉OC₂H₅ (manufactured by 3M Company, Novec (registered trademark) 7200), and C₂F₅CF(OCH₃)C₃F₇ (manufactured by 3M Company, Novec (registered trademark) 7300).

Examples of the fluorinated alkylamines include perfluorotripropylamine and perfluorotributylamine.

Examples of the fluoroalcohols include 2,2,3,3-tetrafluoropropanol, 2,2,2-trifluoroethanol, and hexafluoroisopropanol.

Preferred non-fluorinated organic solvents are compounds consisting of only hydrogen and carbon atoms and those consisting of only hydrogen, carbon, and oxygen atoms. Examples thereof include hydrocarbons, alcohols, ketones, ethers, and esters.

The liquid medium may be a mixed medium of two or more liquid media.

The content of the compound (1) or the present composition is preferably 0.001 to 10% by mass, particularly preferably 0.01 to 1% by mass in the present coating liquid.

The content of the liquid medium is preferably 90 to 99.999% by mass, particularly preferably 99 to 99.99% by mass in the present coating liquid.

### [Article]

The article according to the present invention (hereinafter, also referred to as “the present article”) includes a substrate and a surface layer formed of the compound (1) or the present composition on a surface of the substrate. The surface layer may be formed on part of the surface of the substrate, or may be formed across the surface of the substrate. The surface layer may extend across the surface of the substrate in the form of a film, or may be present as dots.

The surface layer contains the compound (1) having hydrolyzable silyl groups partially or completely hydrolyzed and silanol groups subjected to a dehydration condensation reaction.

The thickness of the surface layer is preferably 1 to 100 nm, particularly preferably 1 to 50 nm. A surface layer having a thickness of 1 nm or more readily provides a sufficient effect by the surface treatment. A surface layer having a thickness of 100 nm or less provides high use efficiency. The thickness of the surface layer can be determined by obtaining the interference pattern of the reflected X-ray by X-ray reflectance using an X-ray diffraction meter for thin film analysis (manufactured by RIGAKU Corporation, ATX-G) and calculating the thickness from the vibration period of the interference pattern.

Examples of the substrate include substrates which should have water/oil repellency. Examples thereof include substrates used in contact with other articles (such as a stylus) or a hand or finger of a person, those held by the hand or finger of a person during operation, and ^{those} placed on other articles (such as a stand).

Examples of the material for the substrate include metals, resins, glass, sapphire, ceramics, stones, and composite materials thereof. Glass may be chemically strengthened. The substrate may include an undercoating such as an SiO₂ film formed on the surface thereof.

Suitable substrates are substrates for touch panels, substrates for displays, and lenses for eye glasses. Substrates for touch panels are particularly suitable. A preferred material for the substrates for touch panels is glass or a transparent resin.

The substrate is also preferably glass or a resin film used in exteriors of devices (excluding the display unit) such as mobile phones (such as smartphones), personal digital assistants (such as tablet terminals), game machines, and remote controllers.

### [Method of Producing Article]

The present article can be produced by the following method, for example.
A method of treating the surface of the substrate by dry coating method using the compound (1) or the present composition to form a surface layer of the compound (1) or the present composition on the surface of the substrate.
A method of applying the present coating liquid onto the surface of the substrate by wet coating method, and drying the coating to form a surface layer of the compound (1) or the present composition on the surface of the substrate.

Examples of dry coating method include vacuum deposition, CVD, and sputtering. A preferred method for dry coating is vacuum evaporation because it prevents decomposition of the compound (1) and the apparatus is simple. In vacuum deposition, a pelletized substance of a porous metal (such as iron or steel) impregnated with the compound (1) or the present composition may be used. Another pelletized substance impregnated with the compound (1) or the present composition may be used, which is prepared by impregnating a porous metal (such as iron or steel) with the present coating liquid, and drying the liquid medium.

Examples of wet coating method include spin coating, wipe coating, spray coating, squeegee coating, dip coating, die coating, ink jetting, flow coating, roll coating, casting, a Langmuir-Blodgett method, and gravure coating.

### EXAMPLES

Hereinafter, the present invention will be more specifically described by way of Examples, but these Examples should not be construed as limitations to the present invention. Thereafter, “%” is “% by mass” unless otherwise specified. Examples 1 to 4, 9 to 12 are Examples, and Example 5 to 8 and 13 to 16 are Comparative Examples.

### Example 1

### Example 1-1

5.51 g of adiponitrile (manufactured by Tokyo Chemical Industry Co., Ltd.) and 500 mL of tetrahydrofuran (hereinafter, also referred to as “THF”) were placed into a 1000-mL four-necked flask, and were stirred under a nitrogen atmosphere while being cooled in a dry ice-acetone bus. Subsequently, 50 mL of a hexane solution of lithium diisopropylamide (1.1 mol/L, manufactured by Sigma-Aldrich Corporation) was slowly added, and then 7.5 g of allyl bromide (manufactured by Tokyo Chemical Industry Co., Ltd.) was slowly added. This operation was repeated four times. The hexane solution of lithium diisopropylamide was added in a total amount of 200 mL, and allyl bromide was added in a total amount of 29.9 g. The content of the flask was stirred for 12 hours while its temperature was being slowly returned to 25° C. Subsequently, 300 mL of 1N hydrochloric acid aqueous solution was added, and was separated with methylene chloride. The resulting organic layer was dried over magnesium sulfate, and solids were removed through filtration to concentrate the liquid. The resulting crude product was refined by silica gel chromatography to yield 5.47 g of a compound (8-1).

¹H-NMR (300.4 MHz, solvent: CDCl₃, reference: tetramethylsilane) δ (ppm): 5.9-5.7 (4H), 5.4-5.1 (8H), 2.3 (8H), 1.7 (4H).

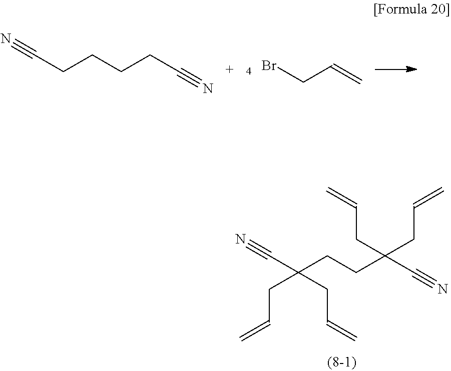

### Example 1-2

5.47 g of the compound (8-1) prepared in Example 1-1 and 500 mL of THF were added to a 1000-mL four-necked flask, and were stirred under a nitrogen atmosphere with the flask put in an ice bath. Subsequently, a THF solution of lithium aluminum hydride (2.5 mol/L, manufactured by Tokyo Chemical Industry Co., Ltd.) was slowly added. The content of the flask was slowly stirred for 14 hours while its temperature was being slowly returned to 25° C. Subsequently, 2 mL of deionized water and 2 mL of a 15% sodium hydroxide aqueous solution were added, followed by stirring. 6 mL of deionized water was further added, followed by stirring. Precipitated solids were removed through cerite filtration to yield 5.64 g of a crude product of a compound (4-1).

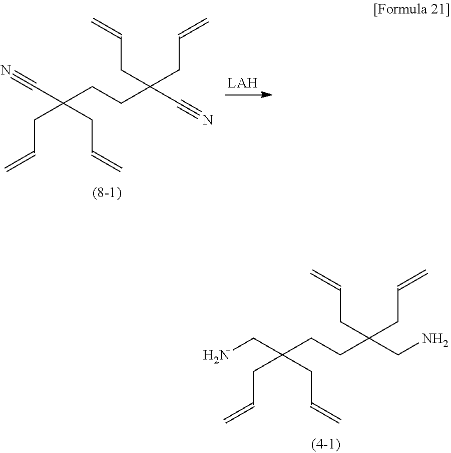 [SMILES: C=CCC(C#N)(CC=C)CCC(C#N)(CC=C)CC=C ; C=CCC(CN)(CC=C)CCC(CN)(CC=C)CC=C]

### Example 1-3

A compound (5-1) was prepared by the method according to Example 1 in WO2008/026707. The compound (5-1) was reacted with methanol to yield compound (5-2).

CF₃CF₂OCF₂CF₂OCF₂C(O)F (5-1)

CF₃CF₂OCF₂CF₂OCF₂C(O)OCH₃ (5-2)

16.36 g of the compound (5-2) was added to the crude product of the compound (4-1) prepared in Example 1-2, followed by stirring at 25° C. for 3 hours. Subsequently, the reaction product was concentrated, and was refined by silica gel chromatography to yield 9.24 g of a compound (6-1).

¹H-NMR (300.4 MHz, solvent: CDCl₃, reference: tetramethylsilane) δ (ppm): 6.9 (2H), 5.9-5.7 (4H), 5.2-5.0 (8H), 3.2 (4H), 2.0 (8H), 1.3 (4H).

¹⁹F-NMR (282.7 MHz, solvent: CDCl₃, reference: C₆F₆) δ (ppm): −79 (4F), −87 (6F), −88-−89 (12F).

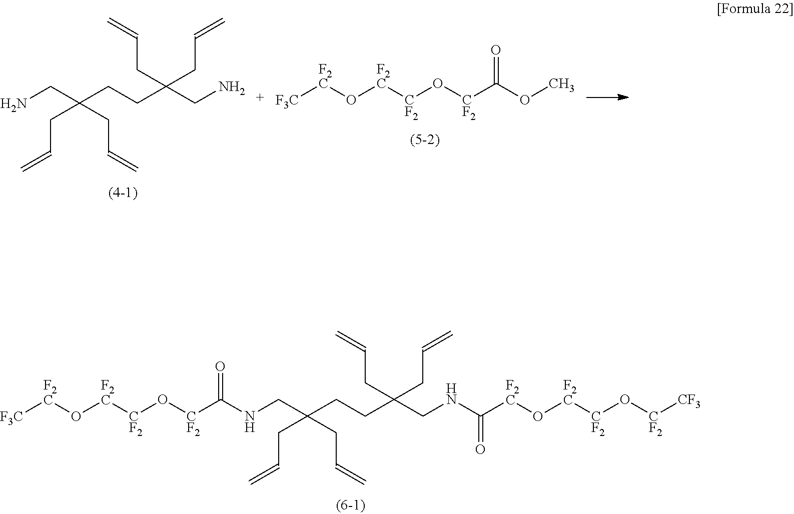 [SMILES: C=CCC(CN)(CC=C)CCC(CN)(CC=C)CC=C ; COC(=O)C(F)(F)OC(F)(F)C(F)(F)OC(F)(F)C(F)(F)F ; C=CCC(CC=C)(CCC(CC=C)(CC=C)CNC(=O)C(F)(F)OC(F)(F)C(F)(F)OC(F)(F)C(F)(F)F)CNC(=O)C(F)(F)OC(F)(F)C(F)(F)OC(F)(F)C(F)(F)F]

### Example 1-4

5.04 g of the compound (6-1) prepared in Example 1-3 and 100 mL of THF were added to a 200-mL eggplant flask, and were stirred at 25° C. Subsequently, 7 mL of a THF solution (2.5 mol/L) of lithium aluminum hydride was slowly added dropwise, followed by stirring with heating under reflux for 13 hours. Subsequently, the reaction system was cooled with an ice bath, and 0.6 mL of deionized water and 1.8 mL of a 15% sodium hydroxide aqueous solution were added, followed by stirring. 1.8 mL of deionized water was further added, followed by stirring. Precipitated solids were removed through cerite filtration, and the solvent was distilled off. The resulting crude product was refined by silica gel chromatography to yield 2.4 g of a compound (7-1).

¹H-NMR (300.4 MHz, solvent: CDCl₃, reference: tetramethylsilane) δ (ppm): 5.9-5.7 (4H), 5.2-5.0 (8H), 3.2 (4H), 2.5 (4H), 2.0 (8H), 1.3 (4H).

¹⁹F-NMR (282.7 MHz, solvent: CDCl₃, reference: C₆F₆) δ (ppm): −76 (4F), −87 (6F), −88-−89 (12F).

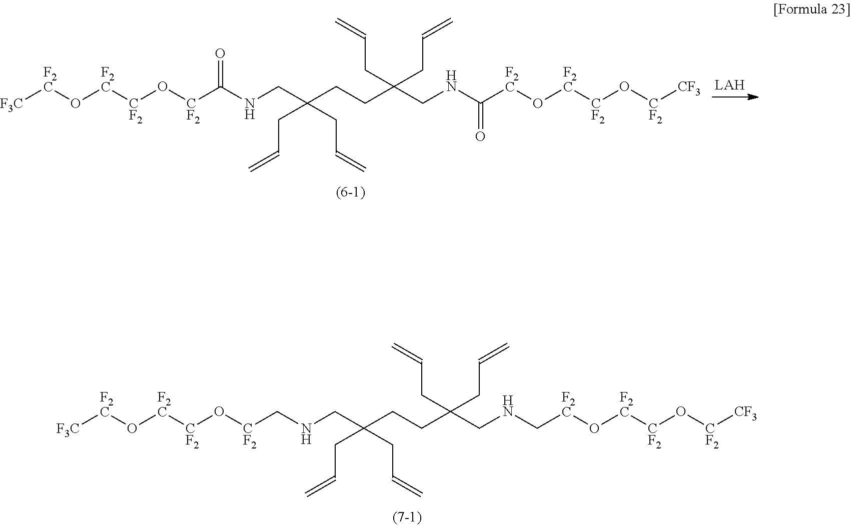 [SMILES: C=CCC(CC=C)(CCC(CC=C)(CC=C)CNC(=O)C(F)(F)OC(F)(F)C(F)(F)OC(F)(F)C(F)(F)F)CNC(=O)C(F)(F)OC(F)(F)C(F)(F)OC(F)(F)C(F)(F)F ; C=CCC(CC=C)(CCC(CC=C)(CC=C)CNCC(F)(F)OC(F)(F)C(F)(F)OC(F)(F)C(F)(F)F)CNCC(F)(F)OC(F)(F)C(F)(F)OC(F)(F)C(F)(F)F]

### Example 1-5

Under a nitrogen atmosphere, 0.62 g of the compound (7-1) prepared in Example 1-4, 1.28 g of triethylamine, and 13 mL of methylene chloride were placed into a 20 mL vial, and were stirred at 25° C. Subsequently, 1.04 g of the compound (5-1) prepared in Example 1-3 was added, followed by stirring at 25° C. for 2 hours. 0.37 g of the compound (5-1) was further added, followed by stirring for 12 hours. After extraction with a 1N hydrochloric acid aqueous solution, the resulting organic layer was dried over magnesium sulfate, and was concentrated. Subsequently, the product was refined by silica gel chromatography to yield 1.00 g of a compound (2a-1).

¹H-NMR (300.4 MHz, solvent: CDCl₃, reference: tetramethylsilane) δ (ppm): 5.9-5.7 (4H), 5.2-5.0 (8H), 4.1 (4H), 3.5 (4H), 2.0 (8H), 1.3 (4H).

¹⁹F-NMR (282.7 MHz, solvent: CDCl₃, reference: C₆F₆) δ (ppm): −70-−73 (8F), −87 (12F), −88-−89 (24F).

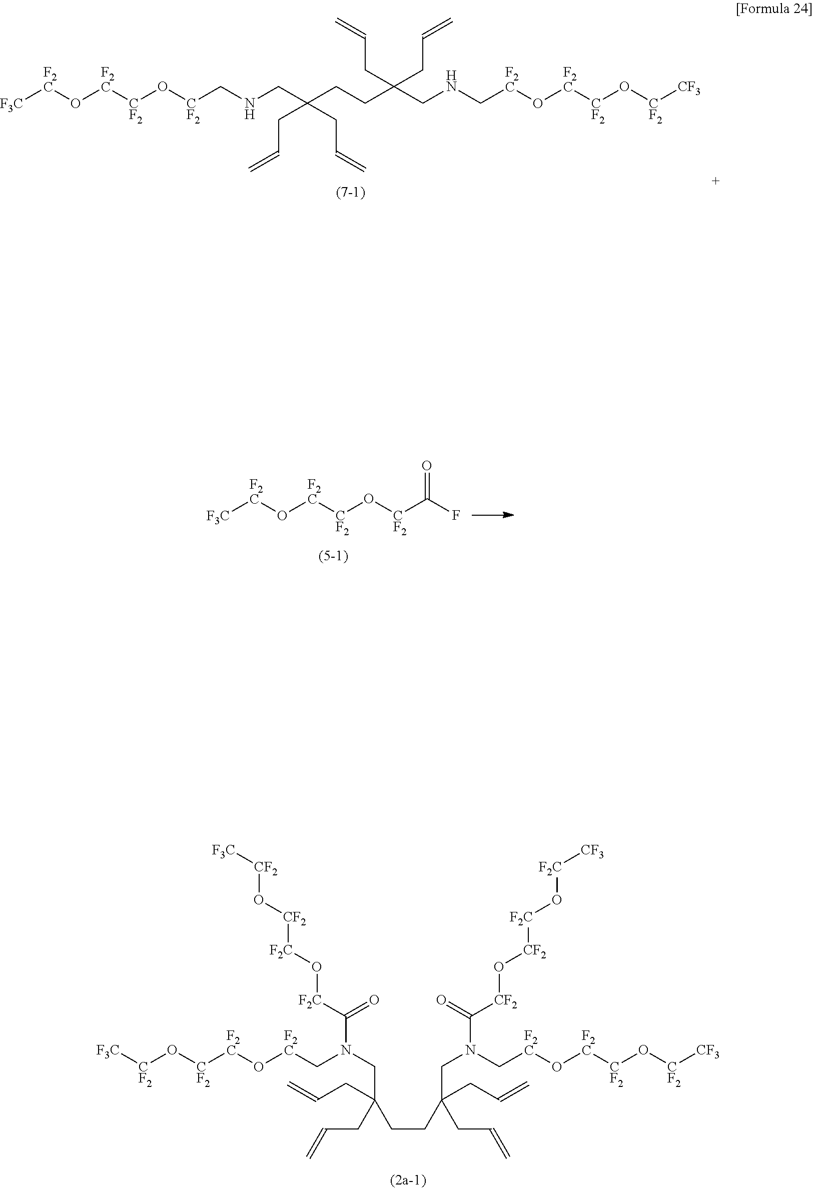 [SMILES: C=CCC(CC=C)(CCC(CC=C)(CC=C)CNCC(F)(F)OC(F)(F)C(F)(F)OC(F)(F)C(F)(F)F)CNCC(F)(F)OC(F)(F)C(F)(F)OC(F)(F)C(F)(F)F ; O=C(F)C(F)(F)OC(F)(F)C(F)(F)OC(F)(F)C(F)(F)F ; C=CCC(CC=C)(CCC(CC=C)(CC=C)CN(CC(F)(F)OC(F)(F)C(F)(F)OC(F)(F)C(F)(F)F)C(=O)C(F)(F)OC(F)(F)C(F)(F)OC(F)(F)C(F)(F)F)CN(CC(F)(F)OC(F)(F)C(F)(F)OC(F)(F)C(F)(F)F)C(=O)C(F)(F)OC(F)(F)C(F)(F)OC(F)(F)C(F)(F)F]

### Example 1-6

Under a nitrogen atmosphere, 3.5 mg of aniline, 5.2 mg of a platinum(O)-1,3-divinyltetramethyldisiloxane complex, and 10 g of 1,1,1,2,2,3,3,4,4,5,5,6,6-tridecafluorooctane (manufactured by AGC Inc., AC-6000) were mixed to prepare a catalyst solution. Under a nitrogen atmosphere, 0.51 g of the compound (2a-1) prepared in Example 1-5, 0.18 g of trimethoxysilane, and 0.52 g of the catalyst solution were laced into a 5 mL vial, and were stirred at 40° C. for 3 days. Subsequently, the solvent was distilled off to yield 0.58 g of a compound (1-1).

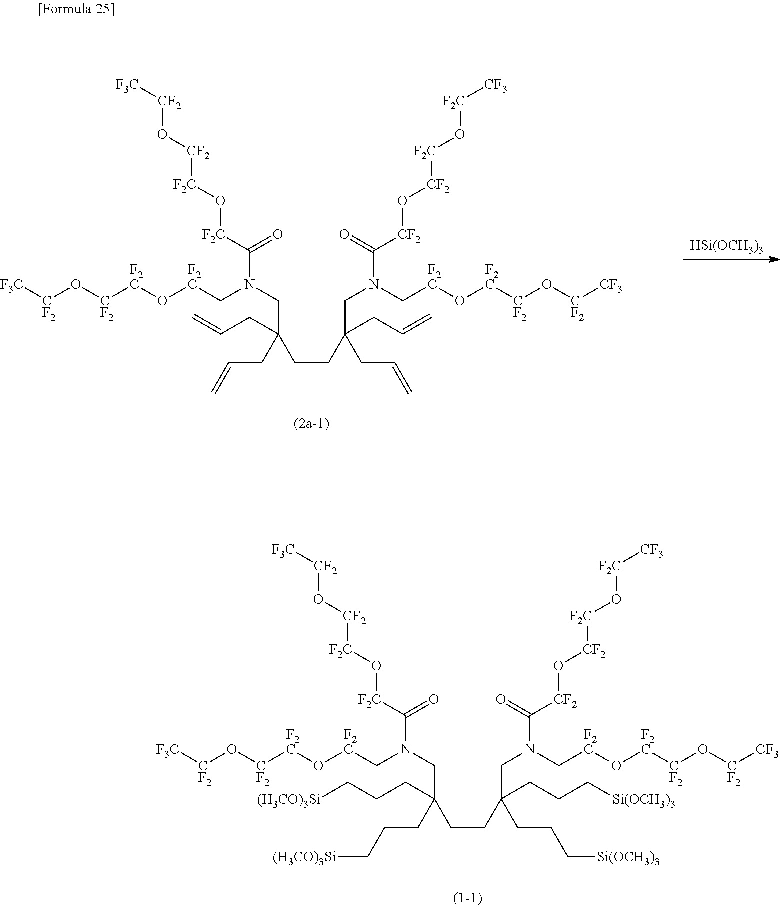

¹H-NMR (300.4 MHz, solvent: CDCl₃, reference: tetramethylsilane) δ (ppm): 4.1 (4H), 3.6-3.4 (40H), 1.5-1.0 (20H), 0.5 (8H).

¹⁹F-NMR (282.7 MHz, solvent: CDCl₃, reference: C₆F₆) δ (ppm): −70-−73 (8F), −87 (12F), −88-−89 (24F).

### Example 2

### Example 2-1

A compound (4-2) (2,2-diallylpropane-1,3-diamine) was prepared in the same method as in Examples 1-1 and 1-2 except that the starting raw material in Example 1-1, i.e., adiponitrile was replaced with malononitrile.

Under a nitrogen atmosphere, 13.8 g of the compound (5-2) prepared in Example 1-3 was placed into a 50-mL three-necked flask, followed by stirring with the flask put in an ice bath. Subsequently, 2.46 g of the compound (4-2) was added over 2 hours, followed by stirring for 3 hours. A crude product was refined by silica gel chromatography to yield 12.3 g of a compound (6-2).

¹H-NMR (300.4 MHz, solvent: CDCl₃, reference: tetramethylsilane) δ (ppm): 5.93-5.84 (2H, m), 5.22-5.12 (4H, m), 3.20 (4H, d, J=6.9 Hz), 2.03 (4H, d, J=7.3 Hz).

¹⁹F-NMR (282.7 MHz, solvent: CDCl₃, reference: C₆F₆) δ (ppm): −78.50 (4F, t, J=12.0 Hz), −87.00 (6F, s), −88.69 (4F, t, J=12.0 Hz), −88.82 (8F, s).

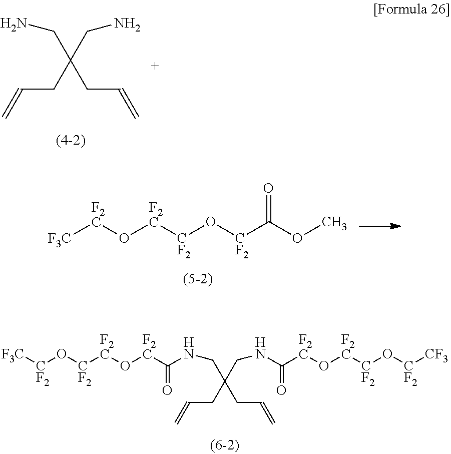 [SMILES: C=CCC(CN)(CN)CC=C ; COC(=O)C(F)(F)OC(F)(F)C(F)(F)OC(F)(F)C(F)(F)F ; C=CCC(CC=C)(CNC(=O)C(F)(F)OC(F)(F)C(F)(F)OC(F)(F)C(F)(F)F)CNC(=O)C(F)(F)OC(F)(F)C(F)(F)OC(F)(F)C(F)(F)F]

### Example 2-2

9.18 g of the compound (6-2) prepared in Example 2-1 and 1000 mL of THF were placed into a 1000-mL eggplant flask, and were stirred at 25° C. Subsequently, 30 mL of a THF solution (2.5 mol/L) of lithium aluminum hydride was slowly added dropwise, followed by stirring with heating under reflux for 16 hours. Subsequently, the reaction system was cooled with an ice bath, and sodium sulfate decahydrate was added under stirring until the reaction system no longer foamed. Precipitated solids were removed through cerite filtration, and the solvent was distilled off. The resulting crude product was refined by silica gel chromatography to yield 7.38 g of a compound (7-2).

1H-NMR (300.4 MHz, solvent: CDCl₃, reference: tetramethylsilane) δ (ppm): 5.86-5.72 (2H, m), 5.09-5.03 (4H, m), 3.15 (4H, t, J=10.5 Hz), 2.58 (4H, s), 2.03 (4H, d, J=7.5 Hz), 1.49 (2H, s).

¹⁹F-NMR (282.7 MHz, solvent: CDCl₃, reference: C₆F₆) δ (ppm): −75.67-−75.84 (4F, m), −87.03 (6F, s), −88.87-−89.04 (8F, m), −89.16-−89.22 (4F, m).

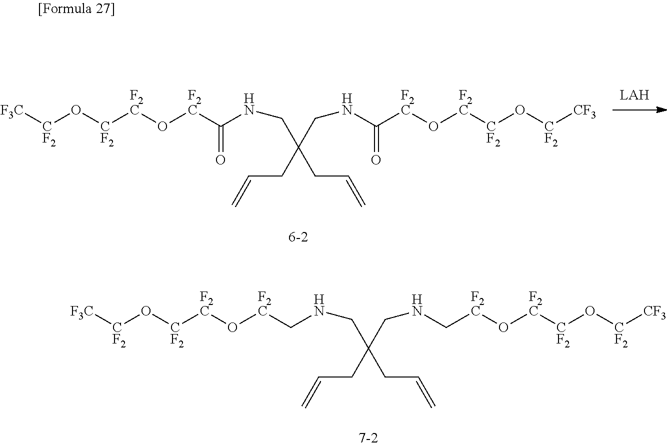 [SMILES: C=CCC(CC=C)(CNC(=O)C(F)(F)OC(F)(F)C(F)(F)OC(F)(F)C(F)(F)F)CNC(=O)C(F)(F)OC(F)(F)C(F)(F)OC(F)(F)C(F)(F)F ; C=CCC(CC=C)(CNCC(F)(F)OC(F)(F)C(F)(F)OC(F)(F)C(F)(F)F)CNCC(F)(F)OC(F)(F)C(F)(F)OC(F)(F)C(F)(F)F]

### Example 2-3

Under a nitrogen atmosphere, 1.10 g of the compound (7-2) prepared in Example 2-2, 2.89 g of triethylamine, and 25 mL of methylene chloride were placed into a 50-mL three-necked flask, were stirred at 25° C. Subsequently, 2.30 g of the compound (5-1) prepared in Example 1-3 was added, followed by stirring at 25° C. for 2 hours. 1.52 g of the compound (5-1) was further added, followed by stirring for 3 hours. Subsequently, 1.65 g of the compound (5-1) was further added, followed by stirring for 21 hours. 60 mL of a 1N hydrochloric acid aqueous solution was added, followed by extraction 3 times using 50 mL of methylene chloride. The resulting organic layer was dried over magnesium sulfate, and was concentrated. Subsequently, the product was refined by silica gel chromatography to yield 0.61 g of a compound (2a-2).

¹H-NMR (300.4 MHz, solvent: CDCl₃, reference: tetramethylsilane) δ (ppm): 5.87-5.73 (2H, m), 5.25-5.08 (4H, m), 4.12 (4H, t, J=8.8 Hz), 3.56 (4H, s), 2.07 (4H, d, J=6.9 Hz).

⁹F-NMR (282.7 MHz, solvent: CDCl₃, reference: C₆F₆) δ (ppm): −71.09 (4F, s), −71.82 (4F, s), −87.50 (6F, s), −87.53 (6F, s), −88.84-−89.72 (24F, m).

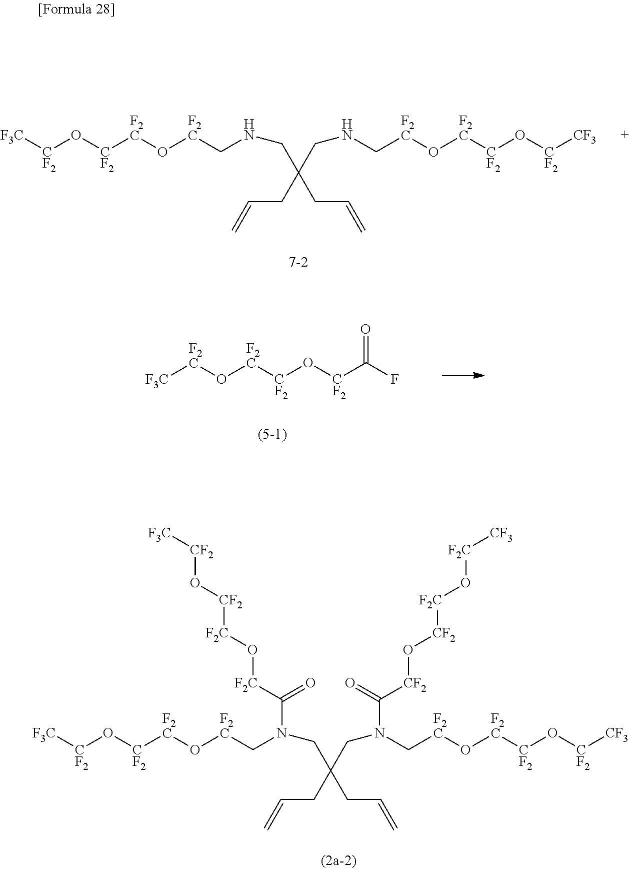 [SMILES: C=CCC(CC=C)(CNCC(F)(F)OC(F)(F)C(F)(F)OC(F)(F)C(F)(F)F)CNCC(F)(F)OC(F)(F)C(F)(F)OC(F)(F)C(F)(F)F ; O=C(F)C(F)(F)OC(F)(F)C(F)(F)OC(F)(F)C(F)(F)F ; C=CCC(CC=C)(CN(CC(F)(F)OC(F)(F)C(F)(F)OC(F)(F)C(F)(F)F)C(=O)C(F)(F)OC(F)(F)C(F)(F)OC(F)(F)C(F)(F)F)CN(CC(F)(F)OC(F)(F)C(F)(F)OC(F)(F)C(F)(F)F)C(=O)C(F)(F)OC(F)(F)C(F)(F)OC(F)(F)C(F)(F)F]

### Example 2-4

Under a nitrogen atmosphere, 0.56 g of the compound (2a-2) prepared in Example 2-3, 0.12 g of trimethoxysilane, 1.9 mg of aniline, 5.2 mg of a platinum(O)-1,3-divinyltetramethyldisiloxane complex, and 0.63 g of AC-6000 were placed into a 5 mL vial, and were stirred at 40° C. for 3 hours. Subsequently, the solvent was distilled off to yield 0.65 g of a compound (1-2).

²H-NMR (300.4 MHz, solvent: CDCl₃, reference: tetramethylsilane) δ (ppm): 4.11 (4H, t, J=8.9 Hz), 3.51 (18H, s), 3.51 (4H, s), 1.38 (4H, t, J=6.0 Hz), 1.26 (4H, t, J=7.6 Hz), 0.54 (4H, t, J=7.2 Hz).

¹⁹F-NMR (282.7 MHz, solvent: CDCl₃, reference: C₆F₆) δ (ppm): −71.09 (4F, s), −71.82 (4F, s), −87.50 (6F, s), −87.53 (6F, s), −88.84-−89.72 (24F, m).

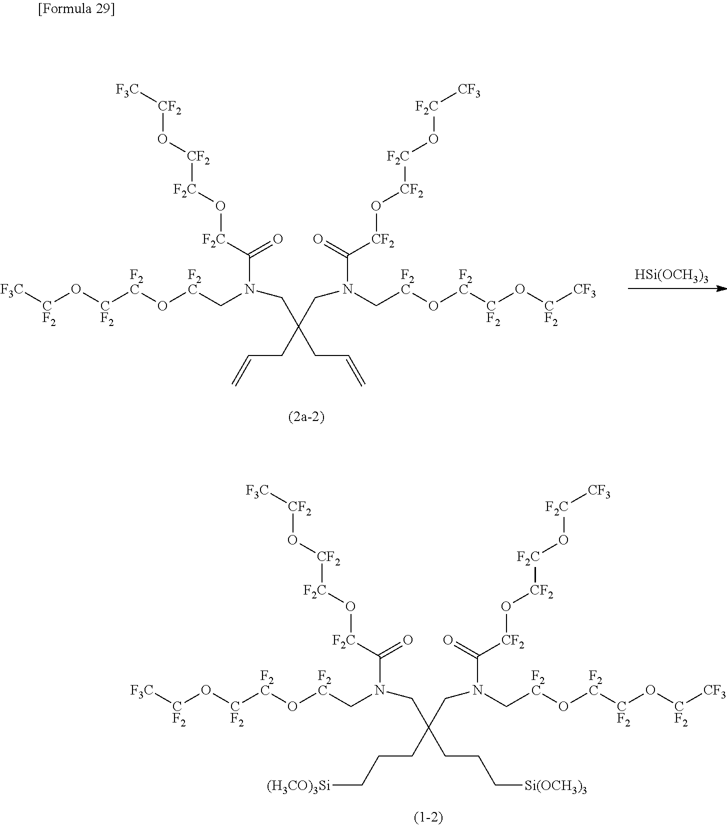

### Example 3

### Example 3-1

A compound (4-3) was prepared by the same method as in Examples 1-1 and 1-2 except that the starting raw material in Example 1-1, i.e., adiponitrile was replaced with acetonitrile.

Under a nitrogen atmosphere, 2.45 g of the compound (5-2) prepared in Example 1-3 was placed into a 50-mL three-necked flask, and was stirred with the flask put in an ice bath. Subsequently, 1.04 g of the compound (4-3) was added, followed by stirring for 7 hours. A crude product was refined by silica gel chromatography to yield 2.89 g of a compound (6-3).

¹H-NMR (300.4 MHz, solvent: CDCl₃, reference: tetramethylsilane) δ (ppm): 6.5 (1H), 6.0-5.7 (3H), 5.2-5.0 (6H), 3.3 (2H), 2.0 (6H).

¹⁹F-NMR (282.7 MHz, solvent: CDCl₃, reference: C₆F₆) δ (ppm): −76 (2F), −87 (3F), −89 (6F).

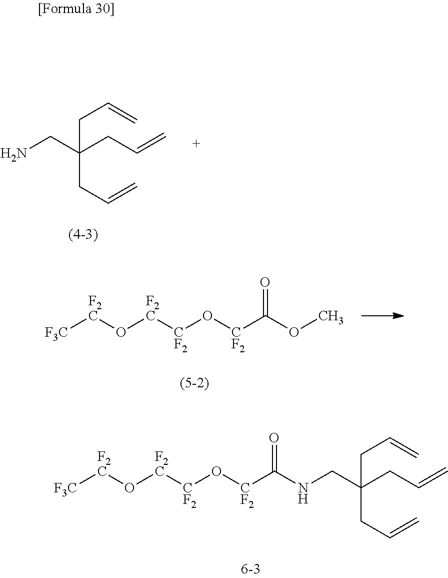 [SMILES: C=CCC(CN)(CC=C)CC=C ; COC(=O)C(F)(F)OC(F)(F)C(F)(F)OC(F)(F)C(F)(F)F ; C=CCC(CC=C)(CC=C)CNC(=O)C(F)(F)OC(F)(F)C(F)(F)OC(F)(F)C(F)(F)F]

### Example 3-2

2.0 g of the compound (6-3) prepared in Example 3-1 and 200 mL of THF were placed into a 300-mL eggplant flask, and were stirred at 25° C. Subsequently, 10 mL of a THF solution (2.5 mol/L) of lithium aluminum hydride was slowly added dropwise, followed by stirring with heating under reflux for 16 hours. Subsequently, the reaction system was cooled with an ice bath, and sodium sulfate decahydrate was added under stirring until the reaction system no longer foamed. Precipitated solids were removed through cerite filtration, and the solvent was distilled off. The resulting crude product was refined by silica gel chromatography to yield 0.92 g of a compound (7-3).

¹H-NMR (300.4 MHz, solvent: CDCl₃, reference: tetramethylsilane) δ (ppm): 6.0-5.7 (3H), 5.2-5.0 (6H), 3.1 (2H), 2.5 (2H), 2.0 (6H).

¹⁹F-NMR (282.7 MHz, solvent: CDCl₃, reference: C₆F₆) δ (ppm): −76 (2F), −87 (3F), −88-−89 (6F).

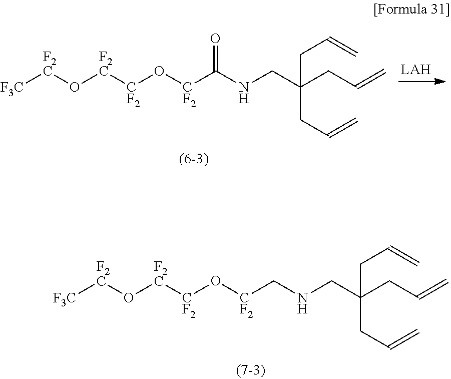 [SMILES: C=CCC(CC=C)(CC=C)CNC(=O)C(F)(F)OC(F)(F)C(F)(F)OC(F)(F)C(F)(F)F ; C=CCC(CC=C)(CC=C)CNCC(F)(F)OC(F)(F)C(F)(F)OC(F)(F)C(F)(F)F]

### Example 3-3

Under a nitrogen atmosphere, 0.92 g of the compound (7-3) prepared in Example 3-2, 3 mL of triethylamine, and 21 mL of methylene chloride were placed into a 50-mL three-necked flask, and were stirred at 25° C. Subsequently, 1.81 g of the compound (5-1) prepared in Example 1-3 was added, followed by stirring at 25° C. for 2 hours. Subsequently, 1.54 g of the compound (5-1) was further added, followed by stirring for 2 hours. After extraction with a 1N hydrochloric acid aqueous solution, the resulting organic layer was dried over magnesium sulfate, and was concentrated. Subsequently, the product was refined by silica gel chromatography to yield 1.42 g of a compound (2a-3).

¹H-NMR (300.4 MHz, solvent: CDCl₃, reference: tetramethylsilane) δ (ppm): 5.9-5.7 (3H), 5.2-5.0 (6H), 4.1 (2H), 3.5 (2H), 2.0 (6H).

¹⁹F-NMR (282.7 MHz, solvent: CDCl₃, reference: C₆F₆) δ (ppm): −72-−76 (4F), −89 (6F), −92 (12F).

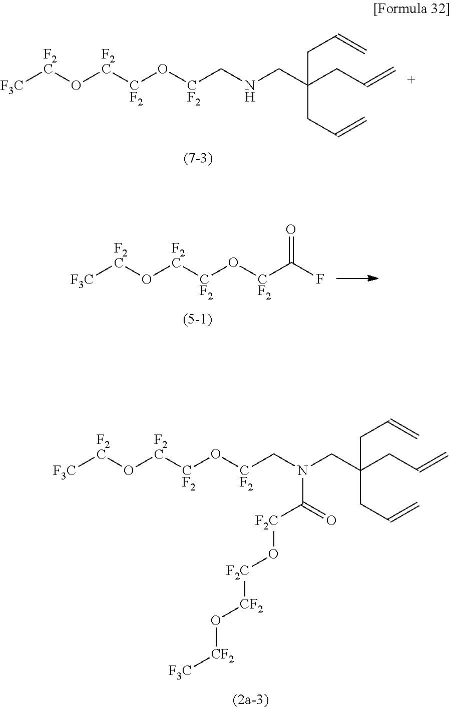 [SMILES: C=CCC(CC=C)(CC=C)CNCC(F)(F)OC(F)(F)C(F)(F)OC(F)(F)C(F)(F)F ; O=C(F)C(F)(F)OC(F)(F)C(F)(F)OC(F)(F)C(F)(F)F ; C=CCC(CC=C)(CC=C)CN(CC(F)(F)OC(F)(F)C(F)(F)OC(F)(F)C(F)(F)F)C(=O)C(F)(F)OC(F)(F)C(F)(F)OC(F)(F)C(F)(F)F]

### Example 3-4

Under a nitrogen atmosphere, 0.55 g of the compound (2a-3) prepared in Example 3-3, 0.36 g of trimethoxysilane, 1.9 mg of aniline, 3.2 mg of a platinum(O)-1,3-divinyltetramethyldisiloxane complex, and 0.55 g of AC-6000 were placed into a 5 mL vial, and were stirred at 40° C. for 3 hours. Subsequently, the solvent was distilled off to yield 0.77 g of a compound (1-3).

¹H-NMR (300.4 MHz, solvent: CDCl₃, reference: tetramethylsilane) δ (ppm): 4.1 (2H), 3.7 (27H), 3.2 (7H), 1.4 (6H), 1.2 (6H), 1.5 (6H).

¹⁹F-NMR (282.7 MHz, solvent: CDCl₃, reference: C₆F₆) δ (ppm): −72-−76 (4F), −89 (6F), −92 (12F).

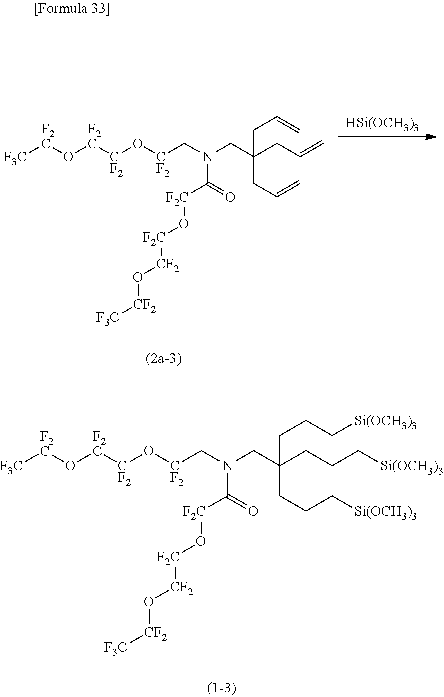

### Example 4

A compound (5-3) was prepared by the method according to Example 1 in WO2009/008380. The mean value of x was 7.

A compound (5-4) was prepared by the method according to Example 1 in WO2009/008380. The mean value of x was 7.

CF₃(OCF₂CF₂)ₓOCF₂C(O)F (5-3)

CF₃(OCF₂CF₂)ₓOCF₂C(O)OCH₂CH₃ (5-4)

A compound (1-4) was prepared in the same manner as in Examples 1-3 to 1-6 except that the compound (5-2) was replaced with the compound (5-4) and the compound (5-1) was replaced with the compound (5-3). The mean value of x is 7. R^{f} has an average molecular weight of 1000.

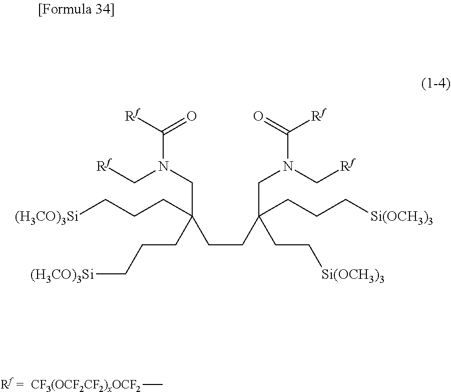

### Example 5

Under a nitrogen atmosphere, 1.05 g of the compound (6-1) prepared in Example 1-3, 0.62 g of trimethoxysilane, 2.8 mg of aniline, 2.8 mg of a platinum(O)-1,3-divinyltetramethyldisiloxane complex, and 1.06 g of AC-6000 were placed into a 20 mL vial, and were stirred at 40° C. for 5 hours. Subsequently, the reaction solution was concentrated to yield 1.6 g of a compound (10-1).

¹H-NMR (300.4 MHz, solvent: CDCl₃, reference: tetramethylsilane) δ (ppm): 7.5 (2H), 3.5 (36H), 3.1 (4H), 1.5-0.9 (20H), 0.5 (8H).

¹⁹F-NMR (282.7 MHz, solvent: CDCl₃, reference: C₆F₆) δ (ppm): −79 (4F), −87 (6F), −88-−89 (12F).

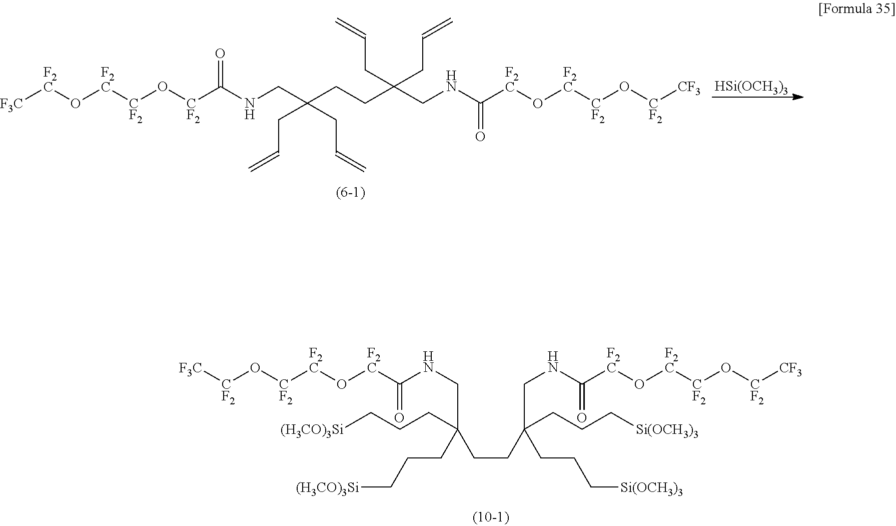

### Example 6

Under a nitrogen atmosphere, 0.50 g of the compound (6-2) prepared in Example 2-1, 0.28 g of trimethoxysilane, 1.2 mg of aniline, 5.8 mg of a platinum(O)-1,3-divinyltetramethyldisiloxane complex, and 0.55 g of AC-6000 were placed into a 5 mL vial, and were stirred at 40° C. for 3 hours. Subsequently, the solvent was distilled off to yield 0.64 g of a compound (10-2).

¹H-NMR (300.4 MHz, solvent: CDCl₃, reference: tetramethylsilane) δ (ppm): 3.6 (18H), 3.2 (4H, s), 1.4 (4H), 1.2 (4H), 0.5 (4H).

¹⁹F-NMR (282.7 MHz, solvent: CDCl₃, reference: C₆F₆) δ (ppm): −78 (4F), −87 (6F), −88 (4F), −88 (8F).

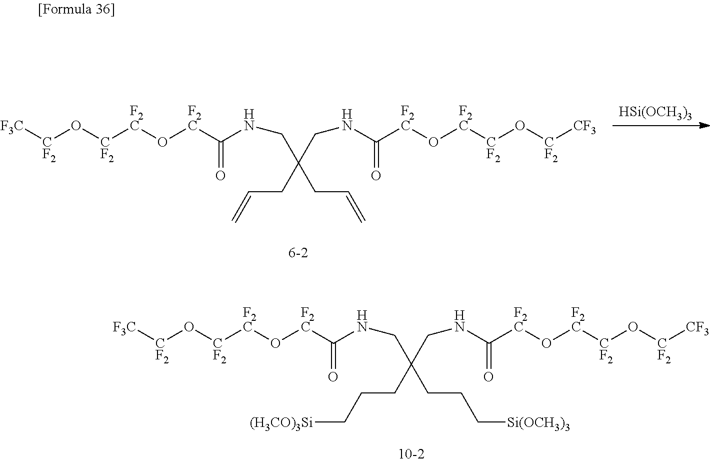

### Example 7

Under a nitrogen atmosphere, 0.60 g of the compound (6-3) prepared in Example 3-1, 0.49 g of trimethoxysilane, 2.2 mg of aniline, 5.2 mg of a platinum(O)-1,3-divinyltetramethyldisiloxane complex, and 0.55 g of AC-6000 were placed into a 5 mL vial, and were stirred at 40° C. for 3 hours. Subsequently, the solvent was distilled off to yield 1.01 g of a compound (10-3).

¹H-NMR (300.4 MHz, solvent: CDCl₃, reference: tetramethylsilane) δ (ppm): 3.7 (27H), 3.2 (2H), 1.4 (6H), 1.2 (6H), 1.5 (6H).

¹⁹F-NMR (282.7 MHz, solvent: CDCl₃, reference: C₆F₆) δ (ppm): −76 (2F), −87 (3F), −89 (6F).

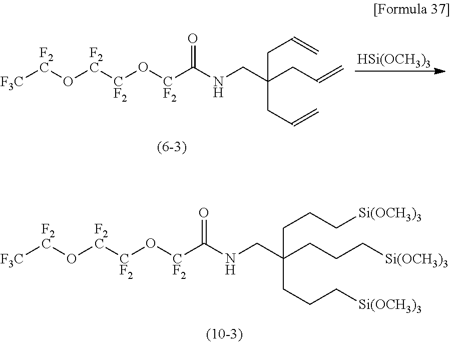

### Example 8

A compound (10-4) was prepared in the same manner as in Examples 1-3 and 5 except that the compound (5-2) was replaced with the compound (5-4) prepared in Example 4. The mean value of x was 7.

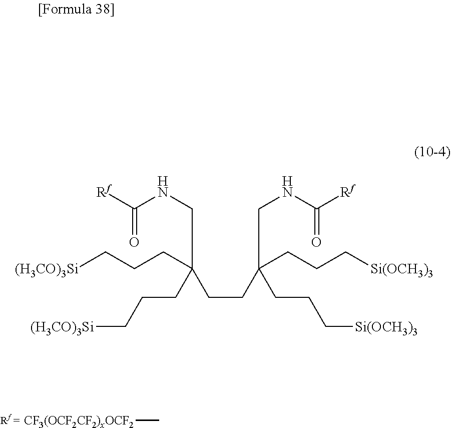

### Examples 9 to 16: Production and Evaluation of Article

Substrates were surface treated with the compounds prepared in Examples 1 to 8 to produce articles in Examples 9 to 16. The surface treatment methods used in Examples were dry coating method and wet coating method below. The substrate used were chemically toughened glass. The produced articles were evaluated by the following method. The results are shown in Table 1.

### Dry Coating Method

Dry coating method was performed using a vacuum deposition apparatus (manufactured by ULVAC, Inc., VTR350M) (vacuum evaporation). For the compounds prepared in Examples 1 to 8, 0.5 g of each compound was filled into a boat made of molybdenum in the vacuum deposition apparatus, the vacuum deposition apparatus was degassed to 1×10⁻³ Pa or less. The boat contained the compound was heated at a heating rate of 10° C./min or less. The shutter was opened when the deposition rate measured with a crystal oscillation-type film thickness meter exceeded 1 nm/sec, and film formation on the surface of the substrate was started. The shutter was closed when the film thickness reached about 50 nm, and film formation on the surface of the substrate was completed. The substrate including the deposited compound was subjected to heat treatment at 200° C. for 30 minutes, and was washed with dichloropentafluoropropane (manufactured by AGC Inc., AK-225) to produce an article including a surface layer on the surface of the substrate.

### Wet Coating Method

The compounds prepared in Examples 1 to 8 were each mixed with a medium C₄F₉OC₂H₅ (manufactured by 3M Company, Novec (registered trademark) 7200) to prepare a coating liquid (solid content: 0.05%). The substrate was dipped into the coating liquid, was left to stand for 30 minutes, and was pulled out (dip coating). The coating was dried at 200° C. for 30 minutes, and was washed with AK-225 to produce an article including a surface layer on the surface of the substrate.

### (Evaluation Method)

### <Method of Measuring Water Contact Angle>

The contact angle of about 2 μL distilled water placed on the surface of the surface layer was measured using a contact angle measurement apparatus (manufactured by Kyowa Interface Science Co., Ltd., DM-500). The surface of the surface layer was measured at different five points, and the average was calculated. The contact angle was calculated by a 2θ method.

### <Initial Water Contact Angle>

The initial water contact angle of the surface layer was measured by the measurement method above. The criteria for evaluation are as follows:

○ (good): 100 degrees or more.

× (failure): less than 100 degrees.

### <Slip Resistance>

An automatic contact angle meter (manufactured by Kyowa Interface Science Co., Ltd., DMo-701) having a main surface held horizontally was prepared. The article was placed on the surface (horizontal surface) of a polyethylene sheet (manufactured by HAGITEC CO. LTD., hard polyethylene sheet (high-density polyethylene)) such that the surface layer was in contact with the surface of the polyethylene sheet. The article was gradually inclined using the automatic contact angle meter to measure the angle (sliding angle) formed by the surface layer of the article and the horizontal surface when the article started sliding. The criteria for determination are shown below. The measurement was performed under the following conditions: contact area between the article and the polyethylene sheet: 6 cm×6 cm, load applied to the article: 0.98 N.

[symbol] (excellent): sliding angle of 5 degrees or more.

○ (good): sliding nngle of 2 degrees or more and less than 5 degrees.

× (failure): sliding angle of less than 2 degrees.

### <Friction Resistance>

According to JIS L0849: 2013 (ISO 105-X12: 2001, a cellulose nonwoven fabric (manufactured by Asahi Kasei Corporation, BEMCOT (registered trademark) M-3) was reciprocated against the surface layer 10000 times at a load of 9.8 N and a rate of 320 cm/min using a reciprocating traverse testing machine (manufactured by KNT Co.), and the water contact angle was measured. A smaller reduction in water repellency (water contact angle) after friction indicates a smaller reduction in performance due to the friction and higher friction resistance. The criteria for evaluation are as follows.

[symbol] (excellent): a change in water contact angle after 10000 reciprocal movements is 10 degrees or less.

○ (good): a change in water contact angle after 10000 reciprocal movements is more than 10 degrees and 15 degrees or less.

× (failure): a change in water contact angle after 10000 reciprocal movements is more than 15 degrees.

### <Fingerprint Marks Removability>

An artificial fingerprint solution (solution of oleic acid and squalene) was applied onto a flat surface of a silicon rubber cap, and excess oil was wiped with a nonwoven fabric (manufactured by Asahi Kasei Corporation, BEMCOT (registered trademark) M-3) to prepare a fingerprint stamp. The fingerprint stamp was placed on the surface layer, and was pressed against it under a load of 9.8 N for 10 seconds. The haze of the portion including a fingerprint marks was measured with a haze meter, and was defined as an initial value. The portion including the fingerprint marks was wiped with tissue paper attached to a reciprocating traverse testing machine (manufactured by KNT Co.) under a load of 4.9 N. The haze value was measured for every reciprocal movement in wiping to count the number of times of wiping when the haze was reduced to 10% or lower of the initial value. A smaller number of times of wiping indicates that removal of fingerprint marks is easier and fingerprint marks wiping out properties are higher. The criteria for evaluation are as follows.

[symbol] (excellent): the number of times of wiping is 3 or less.

○ (good): the number of times of wiping is 4 to 5.

Δ (acceptable): of times of wiping is 6 to 8.

× (failure): the number of times of wiping is 9 or more.

TABLE 1

| | | Example | | | | | | | |
|---|---|---|---|---|---|---|---|---|---|
| | | 9 | 10 | 11 | 12 | 13 | 14 | 15 | 16 |
| | | Fluorinated compound | | | | | | | |
| | | Compound | Compound | Compound | Compound | Compound | Compound | Compound | Compound |
| | | (1-1) | (1-2) | (1-3) | (1-4) | (10-1) | (10-2) | (10-3) | (10-4) |
| Dry coating | Initial water contact angle | ∘ | ∘ | ∘ | ∘ | ∘ | ∘ | ∘ | ∘ |
| | Slip resistance | [symbol] | [symbol] | [symbol] | ∘ | [symbol] | [symbol] | [symbol] | ∘ |
| | Friction resistance | [symbol] | [symbol] | ∘ | [symbol] | x | x | x | x |
| Wet coating | Initial water contact angle | ∘ | ∘ | ∘ | ∘ | ∘ | ∘ | ∘ | ∘ |
| | Slip resistance | ∘ | [symbol] | [symbol] | ∘ | ∘ | [symbol] | [symbol] | ∘ |
| | Friction resistance | [symbol] | [symbol] | ∘ | [symbol] | x | x | x | x |
| | Fingerprint marks removability | ∘ | ∘ | ∘ | [symbol] | Δ | Δ | x | [symbol] |

It was verified that initial water/oil repellency, friction resistance, fingerprint marks removability, and slip resistance are excellent in Examples 9 to 12 using the compound (1A).

### INDUSTRIAL APPLICABILITY

The fluorinated compound according to the present invention can be used in a variety of applications where lubrication and water/oil repellency are required. For example, fluorinated compound according to the present invention can be used in display input devices such as touch panels, surface protective coatings for transparent glass or plastic members, antifouling coats for kitchens, water repellent moisture proof coatings and antifouling coatings for electronic devices, heat exchangers, and batteries, toiletry antifouling coatings, coatings for members which require liquid repellency while conducting electricity, waterproof/water repellent/water sliding coatings for heat exchangers, and surface low friction coatings for vibrating strainers or insides of cylinders. More specific examples of the applications include front surface protective plates, antireflection plates, polarization plates, antiglare plates, or those having a surface treated with antireflection films, which are used displays; a variety of apparatuses including display input devices whose screens are operated with a finger or palm of a person (such as touch panel sheets and touch panel displays of mobile phones and personal digital assistants); decorative building materials for restrooms, bathrooms, lavatories, and kitchens; waterproof coatings for wiring plates; waterproof/water repellent coatings for heat exchangers; water repellent coatings for solar batteries; waterproof/water repellent coatings for printed circuit boards, waterproof/water repellent coatings for housings of electronic devices and electronic components; insulation-enhancing coatings for power transmission lines; waterproof/water repellent coatings for a variety of filters; waterproof coatings for radio wave absorption materials and sound absorption materials; antifouling coatings for bathrooms, kitchen equipment, and toiletry; waterproof/water repellent/water sliding coatings for heat exchangers; surface low friction coatings for vibrating strainers or insides of cylinders; and surface protective coatings for mechanical parts, vacuum apparatus parts, bearing parts, and automobile parts.

What is claimed is:

1. A fluorinated compound which is a compound represented by the following formula (1A) or a compound represented by the following formula (1B):
[(R^{f}-A-)₂N-]ₐ₁Q¹[-T]_{b1} (1A)
[T-]_{b2}[(R^{f}-A-)₂N-]ₐ₂Q²-N(R¹⁰)₁₋ₐ₃(-A-R^{f})ₐ₃-A-Q^{f}-a-N(R¹⁰)₁₋ₐ₃(-A-R^{f})ₐ₃-Q²[-N(-A-R^{f})₂]ₐ₂[-T]_{b2} (1B)
wherein R^{f} is a fluoroalkyl group (having at least one fluorine atom bonded to a terminal carbon atom on an A side) or a group having —O— between carbon atoms of a fluoroalkyl group having two or more carbon atoms (having at least one fluorine atom bonded to the terminal carbon atom on the A side), and two or more R^{f} in the formulae (1A) and (1B) may be the same or different;
Q^{f} is a fluoroalkylene group (having at least one fluorine atom bonded to a terminal carbon atom on an A side) or a group having —O— between carbon atoms of a fluoroalkylene group having two or more carbon atoms (having at least one fluorine atom bonded to the terminal carbon atom on the A side);
A is a divalent organic group having no fluorine atom, and two or more A in the formulae (1A) and (1B) may be the same or different;
Q¹ is a a1+b1 valent organic group;
Q² is a a2+b2+1 valent organic group, and two Q² may be the same or different;
R¹⁰ is a hydrogen atom or a hydrocarbon group having 1 to 6 carbon atoms, and two or more R¹⁰ may be the same or different;
T is —Si(R)_{3-c}(L)_{c};
R is an alkyl group;
L is a hydrolyzable group or a hydroxyl group, and two or more L may be the same or different;
a1 is an integer of 1 or more, a2 is an integer of 0 or more, and two or more [(R^{f}-A-)₂N—] may be the same or different;
a3 is 0 or 1, and a2+a3≥1;
b1 and b2 each are an integer of 2 or more, and two or more T may be the same or different; and
c is 2 or 3; and wherein
in the compound represented by the formula (1B), two monovalent groups bonded through Q^{f} may be the same or different.

2. The fluorinated compound according to claim 1, wherein the compound represented by the formula (1B) is a compound represented by the following formula (1BX):)
{[T-]_{b2}[(R^{f}-A-)₂N-]ₐ₂Q²-N(R¹⁰)₁₋ₐ₃(-A-R^{f})ₐ₃-A-}₂Q^{f} (1BX)

3. The fluorinated compound according to claim 1, wherein R^{f} is a group represented by the following formula (g1a):
R^{f1}—(OR^{f2})ₘ— (g1a)
wherein R^{f1} is a fluoroalkyl group having 1 to 6 carbon atoms (having at least one fluorine atom bonded to the terminal carbon atom on the A side when m is 0);
R^{f2} is a fluoroalkylene group having 1 to 6 carbon atoms (having at least one fluorine atom bonded to the terminal carbon atom on the A side of R^{f2} which is bonded to A); and
m is an integer of 0 or more, and when m is 2 or more, (OR^{f2})ₘ may include two or more OR^{f2}.

4. The fluorinated compound according to claim 1, wherein R^{f} and Q^{f} each have a molecular weight of 50 to 1000.

5. The fluorinated compound according to claim 1, wherein A is —(CH₂)ₙ—, —C(O)—, —(CH₂)ₙ—NHC(O)—, —C(O)NH—(CH₂)ₙ—C(O)—, or —C(O)NH—(CH₂)ₙ— (where n is an integer of 1 or more).

6. The fluorinated compound according to claim 1, wherein Q¹ is a group represented by formula (a2-1) (where a1=d1+d3 and b1=d2+d4), a group represented by formula (g2-2) (where a1=e1 and b1=e2), a group represented by formula (g2-3) (where a1=1 and b1=2), a group represented by formula (g2-4) (where a1=h1 and b1=h2), or a group represented by formula (g2-5) (where a1=i1 and b1=i2); and
Q² is a group represented by the formula (g2-1) (where a2+1=d1+d3 and b2=d2+d4), a group represented by the formula (g2-2) (where a2+1=e1 and b2=e2), a group represented by the formula (g2-3) (where a2+1=1 and b2=2), a group represented by the formula (g2-4) (where a2+1=h1 and b2=h2), or a group represented by the formula (g2-5) (where a2+1=i1 and b2=i2): 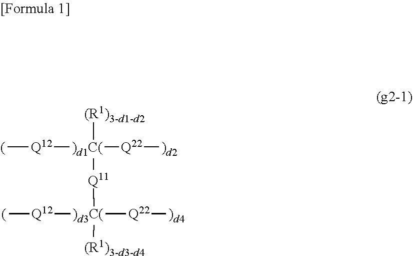
(-Q¹²-)ₑ₁C(R²)₄₋ₑ₁₋ₑ₂(-Q²²-)ₑ₂ (g2-2)
-Q¹³-N(-Q²³-)₂ (g2-3)
(-Q¹⁴-)ₕ₁Z(-Q²⁴-)ₕ₂ (g2-4)
(-Q¹⁵-)ᵢ₁Si(R³)₄₋ᵢ₁₋ᵢ₂(-Q²⁵-)ᵢ₂ (g2-5)
wherein in the formulae (g2-1) to (g2-5), Q¹², Q¹³, Q¹⁴, and Q¹⁵ sides are linked to a nitrogen atom of [(R^{f}-A-)₂N—] or —N(R¹⁰)₁₋ₐ₃(-A-R^{f})ₐ₃—, and Q²², Q²³, Q²⁴, and Q²⁵ sides are linked to T;
Q¹¹is a single bond, —O—, an alkylene group, or a group having —O— between carbon atoms of an alkylene group having two or more carbon atoms;
Q¹² is a single bond, —C(O)—, or an alkylene group, and when Q¹ or Q² has two or more Q¹², the two or more Q¹² may be the same or different;
Q¹³ is an alkylene group;
Q¹⁴ is Q¹² when the atom in Z to which Q¹⁴ is bonded is a carbon atom, and is Q¹³ when the atom in Z to which Q¹⁴ is bonded is a nitrogen atom; and when Q¹ or Q² has two or more Q¹⁴, the two or more Q¹⁴ may be the same or different;
Q¹⁵ is an alkylene group, and when Q¹ or Q² has two or more Q¹⁵, the two or more Q¹⁵ may be the same or different;
Q²² is an alkylene group, a group having —C(O)NH—, —C(O)—, or —O— between carbon atoms of an alkylene group having two or more carbon atoms, a group having —C(O)NH—, —C(O)—, or —O— in a terminal of an alkylene group not linked to Si, or a group having —C(O)NH—, —C(O)—, or —O— between carbon atoms of an alkylene group having two or more carbon atoms and having —C(O)NH—, —C(O)—, or —O— in a terminal not linked to Si, and two or more Q²² may be the same or different;
Q²³ is an alkylene group or a group having —C(O)NH—, —C(O)—, or —O— between carbon atoms of an alkylene group having two or more carbon atoms, and two Q²³ may be the same or different;
Q²⁴ is Q²² when the atom in Z to which Q²⁴ is bonded is a carbon atom, and is Q²³ when the atom in Z to which Q²⁴ is bonded is a nitrogen atom, and two or more Q²⁴ may be the same or different;
Q²⁵ is an alkylene group or a group having —C(O)NH—, —C(O)—, or —O— between carbon atoms of an alkylene group having two or more carbon atoms, and two or more Q²⁵ may be the same or different;
Z is a group having a a1+b1 valent or a2+b2+1 valent cyclic structure having a carbon atom or a nitrogen atom directly bonded by Q¹⁴ and a carbon atom or a nitrogen atom directly bonded by Q²⁴;
R¹ is a hydrogen atom or an alkyl group, and when Q¹ or Q² has two or more R¹, the two or more R¹ may be the same or different;
R² is a hydrogen atom or an alkyl group;
R³ is an alkyl group;
d1 is an integer of 0 to 3, d2 is an integer of 0 to 3, and d1+d2 is an integer of 1 to 3;
d3 is an integer of 0 to 3, d4 is an integer of 0 to 3, and d3+d4 is an integer of 1 to 3;
d1+d3 is an integer of 1 to 4, and d2+d4 is an integer of 2 to 5;
e1 is 1 or 2, e2 is 2 or 3, and e1+e2 is 3 or 4;
h1 is an integer of 1 or more, and h2 is an integer of 2 or more;
i1 is 1 or 2, i2 is 2 or 3, and i1+i2 is 3 or 4.

7. A fluorinated compound-containing composition, comprising at least one type of the fluorinated compound according to claim 1, and other fluorinated compound.

8. A coating liquid, comprising:
the fluorinated compound according to claim 1; and
a liquid medium.

9. An article comprising a substrate and a surface layer formed of the fluorinated compound according to claim 1 on a surface of the substrate.

10. The article according to claim 9, which has the surface layer on a surface of a member constituting a plane of a touch panel to be touched with fingers.

11. A method of producing an article, comprising treating a surface of a substrate by dry coating method using the fluorinated compound according to claim 1 to form a surface layer formed of the fluorinated compound or the fluorinated compound-containing composition on the surface of the substrate.

12. A method of producing an article, comprising applying the coating liquid according to claim 8 onto a surface of a substrate by wet coating method, followed by drying to form a surface layer formed of the fluorinated compound or the fluorinated compound-containing composition on the surface of the substrate.

13. A fluorinated compound which is a compound represented by the following formula (2A) or a compound represented by the following formula (2B):
[(R^{f}-A-)₂N-]ₐ₁Q¹⁰[-CH═CH₂]_{b1} (2A)
[CH₂═CH—]_{b2}[(R^{f}-A-)₂N-]ₐ₂Q²⁰-N(-A-Q^{f}-A-N(-A-R^{f})-Q²⁰[-N(-A-R^{f})₂]ₐ₂[—CH═CH₂]_{b2} (2B)
wherein R^{f} is a fluoroalkyl group (having at least one fluorine atom bonded to a terminal carbon atom on an A side) or a group having —O— between carbon atoms of a fluoroalkyl group having two or more carbon atoms (having at least one fluorine atom bonded to the terminal carbon atom on the A side), and two or more R^{f} in the formulae (2A) and (2B) may be the same or different;
Q^{f} is a fluoroalkylene group (having at least one fluorine atom bonded to a terminal carbon atom on an A side) or a group having —O— between carbon atoms of a fluoroalkylene group having two or more carbon atoms (having at least one fluorine atom bonded to the terminal carbon atom on the A side);
A is a divalent organic group having no fluorine atom, and two or more A in the formulae (2A) and (2B) may be the same or different;
Q¹⁰ is a a1+b1 valent organic group;
Q²⁰ is a a2+b2+1 valent organic group, and two Q²⁰ may be the same or different;
a1 is an integer of 1 or more, a2 is an integer of 0 or more, and two or more [(R^{f}-A-)₂N—] may be the same or different; and
b1 and b2 each are an integer of 2 or more; and wherein
in the compound represented by the formula (2B), two monovalent groups bonded through Q^{f} may be the same or different.

14. The fluorinated compound according to claim 13, wherein the compound represented by the formula (2B) is a compound represented by the following formula (2BX):
{[CH₂═CH—]_{b2}[(R^{f}-A-)₂N-]ₐ₂Q²⁰-N(-A-R^{f})-A-}₂Q^{f} (2BX)

15. A coating liquid, comprising:
fluorinated compound-containing composition according to claim 7; and
a liquid medium.

16. An article comprising a substrate and a surface layer formed of the fluorinated compound-containing composition according to claim 7 on a surface of the substrate.

17. The article according to claim 16, which has the surface layer on a surface of a member constituting a plane of a touch panel to be touched with fingers.

18. A method of producing an article, comprising treating a surface of a substrate by dry coating method using the fluorinated compound-containing composition according to claim 7 to form a surface layer formed of the fluorinated compound or the fluorinated compound-containing composition on the surface of the substrate.

19. A method of producing an article, comprising applying the coating liquid according to claim 15 onto a surface of a substrate by wet coating method, followed by drying to form a surface layer formed of the fluorinated compound or the fluorinated compound-containing composition on the surface of the substrate.
